(19) United States
(12) Patent Application Publication
(10) Pub. No.: US 2010/0149063 A1
(43) Pub. Date: Jun. 17, 2010

(54) DUAL-FREQUENCY ANTENNA

(75) Inventors: Te-Jung CHAN, Hsinchu City (TW); Chih-Jen CHENG, Taipei City (TW); Jun-Zhi CHEN, Banciao City (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 12/336,344

(22) Filed: Dec. 16, 2008

(51) Int. Cl. H01Q 1/48

(52) U.S. Cl. 343/845

(57) ABSTRACT

A dual-frequency antenna includes a substrate, a ground layer, a plurality of signal feed portions, at least one first radiation portion, a plurality of second radiation portions, a plurality of first signal transmission lines, a plurality of second signal transmission lines, a plurality of first filters, and a plurality of second filters. The signal feed portions are disposed between the first radiation portions and the second radiation portions that are disposed on the first surface of the substrate in a staggered manner. The first signal transmission lines and the second signal transmission lines are respectively used to connect the signal feed portions with the first radiation portions and the second radiation portions. The first filters and the second filters are respectively disposed on the first signal transmission lines and the second signal transmission lines. The dual-frequency antenna is applicable for providing broadband and high gain features.

### BACKGROUND OF THE INVENTION

1. Field of the Invention

The present invention relates to an antenna, and more particularly to a dual-frequency antenna.

2. Related Art

With the rapid development of wireless communication technologies, users may perform information transmission via wireless communication systems without being restricted by the topographic features. Accordingly, the antenna has become one of the important elements in the field of wireless communication. Currently, it is more favorable for the manufacturers of antennas through printed circuit boards, which has advantages of a simple manufacturing process and a low cost.

Currently, mobile devices that require an antenna include cell phones, mobile TVs, GPS and the like, and all the mobile devices need to be designed with an appropriate antenna, so as to achieve the best performance. There are more and more products configured with integrated antennas. In order to take both the function and the volume into consideration, the antennas are designed into smaller volume, so as to meet the requirements of mobile phone communication, Wi-Fi, Bluetooth, GPS, and even the requirements about receiving and transmitting digital TV signals. In the future, more and more wireless standards in different specifications will be proposed, and some low-power wireless transmission standards may be applied to mobile phones. Moreover, as there are more and more different application requirements, different antennas shall be combined and used together. Therefore, how to avoid the interferences between different antennas or even how to combine different antennas together will become the key points in the further design.

### SUMMARY OF THE INVENTION

Accordingly, the present invention is directed to a dual-frequency antenna, which adopts a dual-polarized and multi-feed design for improving a field pattern and increasing a bandwidth as compared with the prior art.

The present invention provides a dual-frequency antenna, which includes a substrate, a ground layer, a plurality of signal feed portions, at least one first radiation portion, a plurality of second radiation portions, a plurality of first signal transmission lines, a plurality of second signal transmission lines, a plurality of first filters, and a plurality of second filters.

The substrate has a first surface and a second surface. The ground layer is located on the second surface. The plurality of signal feed portions is located on the first surface. The at least one first radiation portion is located on the first surface. The plurality of second radiation portions is located on the first surface. The plurality of second radiation portions and the at least one first radiation portion have different radiation frequency bands and serially connected in a staggered manner. The plurality of first signal transmission lines is located on the first surface. One end of each of the first signal transmission lines is connected to one of the at least one first radiation portion, and the other end thereof is connected to one of the plurality of signal feed portions. Among the plurality of first signal transmission lines, two first signal transmission lines are connected to same the first radiation portion in a dual-polarized input manner. The plurality of second signal transmission lines is located on the first surface. One end of each of the second signal transmission lines is connected to one of the plurality of second radiation portions, and the other end thereof is connected to one of the plurality of signal feed portions. The plurality of first filters is disposed on the plurality of first signal transmission lines respectively. Each of the first filters is electrically connected between one of the plurality of signal feed portions and one of the at least one first radiation portion. The plurality of second filters is respectively disposed on the plurality of second signal transmission lines, and each of the second filters is electrically connected between one of the plurality of signal feed portions and one of the plurality of second radiation portions.

A plurality of metal layers is correspondingly disposed above one radiation portion of the at least one first radiation portion and the plurality of second radiation portions, and is electrically isolated from the at least one first radiation portion and the plurality of second radiation portions, so as to couple a radiation signal of the corresponding radiation portion. Among the plurality of second signal transmission lines, two second signal transmission lines are connected to the same second radiation portion in a dual-polarized input manner.

In the dual-frequency antenna according to the present invention, when signals with two different frequency bands are fed in by the signal feed portions, and the two different frequency bands of the signals are respectively selected by the first filter and the second filter, and then the two different frequency bands are respectively transferred to a radiation signal of a radiation portion corresponding to each frequency band. Through coupling the metal layer corresponding to and covering each radiation portion, a coupling antenna takes the air between the radiation portion and the metal layer of the antenna as the media, so as to offer a relatively large space for combining the signal transmission lines and relevant circuits, thereby realizing a dual-frequency, dual-polarized, and multi-feed antenna with broadband and high gain features.

### BRIEF DESCRIPTION OF THE DRAWINGS

The present invention will become more fully understood from the detailed description given herein below for illustration only, which thus is not limitative of the present invention, and wherein:

FIG. 1A is a schematic view of a first embodiment of the present invention;

FIG. 1B is a schematic view of first radiation portions according to the present invention;

FIG. 1C is a schematic view of second radiation portions according to the present invention;

FIG. 1D is a schematic view of a multiplexer according to the present invention;

FIG. 2 is an exploded view of a second embodiment of the present invention;

FIG. 3 is a schematic view of the second embodiment of the present invention;

FIG. 4 is a schematic view of a third embodiment of the present invention;

FIG. 5 is an exploded view of a fourth embodiment of the present invention;

FIG. 6 is a schematic view of the fourth embodiment of the present invention;

FIG. 7 is a schematic view of a fifth embodiment of the present invention;

FIG. 8 is a measurement diagram of a standing wave ratio of a first signal feed portion at a frequency of 2.4 GHz-2.5 GHz according to the fourth embodiment of the present invention;

FIG. 9 is a measurement diagram of a standing wave ratio of the first signal feed portion at a frequency of 5.15 GHz-5.875 GHz according to the fourth embodiment of the present invention;

FIG. 10 is a measurement diagram of a standing wave ratio of a second signal feed portion at a frequency of 2.4 GHz-2.5 GHz according to the fourth embodiment of the present invention;

FIG. 11 is a measurement diagram of a standing wave ratio of the second signal feed portion at a frequency of 5.15 GHz-5.875 GHz according to the fourth embodiment of the present invention;

FIG. 12 is a measurement diagram of a standing wave ratio of a third signal feed portion at a frequency of 2.4 GHz-2.5 GHz according to the fourth embodiment of the present invention;

FIG. 13 is a measurement diagram of a standing wave ratio of the third signal feed portion at a frequency of 5.15 GHz-5.875 GHz according to the fourth embodiment of the present invention;

FIG. 14 is an insulation measurement diagram of the first signal feed portion and the second signal feed portion at a frequency of 2.4 GHz-2.5 GHz according to the fourth embodiment of the present invention;

FIG. 15 is an insulation measurement diagram of the second signal feed portion and the third signal feed portion at a frequency of 2.4 GHz-2.5 GHz according to the fourth embodiment of the present invention;

FIG. 16 is an insulation measurement diagram of the second signal feed portion and the third signal feed portion at a frequency of 5.15 GHz-5.875 GHz according to the fourth embodiment of the present invention;

FIG. 17 is an insulation measurement diagram of the first signal feed portion and the third signal feed portion at the frequency of 2.4 GHz-2.5 GHz according to the fourth embodiment of the present invention;

FIG. 18 is an insulation measurement diagram of the first signal feed portion and the third signal feed portion at a frequency of 5.15 GHz-5.875 GHz according to the fourth embodiment of the present invention;

FIG. 19A is a diagram of a horizontal plane pattern of the first signal feed portion at a frequency of 2400 MHz according to the fourth embodiment of the present invention;

FIG. 19B is a diagram of a horizontal plane pattern of the first signal feed portion at a frequency of 2450 MHz according to the fourth embodiment of the present invention;

FIG. 19C is a diagram of a horizontal plane pattern of the first signal feed portion at a frequency of 2500 MHz according to the fourth embodiment of the present invention;

FIG. 20A is a diagram of a horizontal plane pattern of the first signal feed portion at a frequency of 5100 MHz according to the fourth embodiment of the present invention;

FIG. 20B is a diagram of a horizontal plane pattern of the first signal feed portion at a frequency of 5300 MHz according to the fourth embodiment of the present invention;

FIG. 20C is a diagram of a horizontal plane pattern of the first signal feed portion at a frequency of 5500 MHz according to the fourth embodiment of the present invention;

FIG. 20D is a diagram of a horizontal plane pattern of the first signal feed portion at a frequency of 5700 MHz according to the fourth embodiment of the present invention;

FIG. 20E is a diagram of a horizontal plane pattern of the first signal feed portion at a frequency of 5900 MHz according to the fourth embodiment of the present invention;

FIG. 21A is a diagram of a vertical plane pattern of the first signal feed portion at a frequency of 2400 MHz according to the fourth embodiment of the present invention;

FIG. 21B is a diagram of a vertical plane pattern of the first signal feed portion at a frequency of 2450 MHz according to the fourth embodiment of the present invention;

FIG. 21C is a diagram of a vertical plane pattern of the first signal feed portion at a frequency of 2500 MHz according to the fourth embodiment of the present invention;

FIG. 22A is a diagram of a vertical plane pattern of the first signal feed portion at a frequency of 5100 MHz according to the fourth embodiment of the present invention;

FIG. 22B is a diagram of a vertical plane pattern of the first signal feed portion at a frequency of 5300 MHz according to the fourth embodiment of the present invention;

FIG. 22C is a diagram of a vertical plane pattern of the first signal feed portion at a frequency of 5500 MHz according to the fourth embodiment of the present invention;

FIG. 22D is a diagram of a vertical plane pattern of the first signal feed portion at a frequency of 5700 MHz according to the fourth embodiment of the present invention;

FIG. 22E is a diagram of a vertical plane pattern of the first signal feed portion at a frequency of 5900 MHz according to the fourth embodiment of the present invention;

FIG. 23A is a diagram of a horizontal plane pattern of the second signal feed portion at a frequency of 2400 MHz according to the fourth embodiment of the present invention;

FIG. 23B is a diagram of a horizontal plane pattern of the second signal feed portion at a frequency of 2450 MHz according to the fourth embodiment of the present invention;

FIG. 23C is a diagram of a horizontal plane pattern of the second signal feed portion at a frequency of 2500 MHz according to the fourth embodiment of the present invention;

FIG. 24A is a diagram of a horizontal plane pattern of the second signal feed portion at a frequency of 5100 MHz according to the fourth embodiment of the present invention;

FIG. 24B is a diagram of a horizontal plane pattern of the second signal feed portion at a frequency of 5300 MHz according to the fourth embodiment of the present invention;

FIG. 24C is a diagram of a horizontal plane pattern of the second signal feed portion at a frequency of 5500 MHz according to the fourth embodiment of the present invention;

FIG. 24D is a diagram of a horizontal plane pattern of the second signal feed portion at a frequency of 5700 MHz according to the fourth embodiment of the present invention;

FIG. 24E is a diagram of a horizontal plane pattern of the second signal feed portion at a frequency of 5900 MHz according to the fourth embodiment of the present invention;

FIG. 25A is a diagram of a vertical plane pattern of the second signal feed portion at a frequency of 2400 MHz according to the fourth embodiment of the present invention;

FIG. 25B is a diagram of a vertical plane pattern of the second signal feed portion at a frequency of 2450 MHz according to the fourth embodiment of the present invention;

FIG. 25C is a diagram of a vertical plane pattern of the second signal feed portion at a frequency of 2500 MHz according to the fourth embodiment of the present invention;

FIG. 26A is a diagram of a vertical plane pattern of the second signal feed portion at a frequency of 5100 MHz according to the fourth embodiment of the present invention;

FIG. 26B is a diagram of a vertical plane pattern of the second signal feed portion at a frequency of 5300 MHz according to the fourth embodiment of the present invention;

FIG. 26C is a diagram of a vertical plane pattern of the second signal feed portion at a frequency of 5500 MHz according to the fourth embodiment of the present invention;

FIG. 26D is a diagram of a vertical plane pattern of the second signal feed portion at a frequency of 5700 MHz according to the fourth embodiment of the present invention;

FIG. 26E is a diagram of a vertical plane pattern of the second signal feed portion at a frequency of 5900 MHz according to the fourth embodiment of the present invention;

FIG. 27A is a diagram of a horizontal plane pattern of the third signal feed portion at a frequency of 2400 MHz according to the fourth embodiment of the present invention;

FIG. 27B is a diagram of a horizontal plane pattern of the third signal feed portion at a frequency of 2450 MHz according to the fourth embodiment of the present invention;

FIG. 27C is a diagram of a horizontal plane pattern of the third signal feed portion at a frequency of 2500 MHz according to the fourth embodiment of the present invention;

FIG. 28A is a diagram of a horizontal plane pattern of the third signal feed portion at a frequency of 5100 MHz according to the fourth embodiment of the present invention;

FIG. 28B is a diagram of a horizontal plane pattern of the third signal feed portion at a frequency of 5300 MHz according to the fourth embodiment of the present invention;

FIG. 28C is a diagram of a horizontal plane pattern of the third signal feed portion at a frequency of 5500 MHz according to the fourth embodiment of the present invention;

FIG. 28D is a diagram of a horizontal plane pattern of the third signal feed portion at a frequency of 5700 MHz according to the fourth embodiment of the present invention;

FIG. 28E is a diagram of a horizontal plane pattern of the third signal feed portion at a frequency of 5900 MHz according to the fourth embodiment of the present invention;

FIG. 29A is a diagram of a vertical plane pattern of the third signal feed portion at a frequency of 2400 MHz according to the fourth embodiment of the present invention;

FIG. 29B is a diagram of a vertical plane pattern of the third signal feed portion at a frequency of 2450 MHz according to the fourth embodiment of the present invention;

FIG. 29C is a diagram of a vertical plane pattern of the third signal feed portion at a frequency of 2500 MHz according to the fourth embodiment of the present invention;

FIG. 30A is a diagram of a vertical plane pattern of the third signal feed portion at a frequency of 5100 MHz according to the fourth embodiment of the present invention;

FIG. 30B is a diagram of a vertical plane pattern of the third signal feed portion at a frequency of 5300 MHz according to the fourth embodiment of the present invention;

FIG. 30C is a diagram of a vertical plane pattern of the third signal feed portion at a frequency of 5500 MHz according to the fourth embodiment of the present invention;

FIG. 30D is a diagram of a vertical plane pattern of the third signal feed portion at a frequency of 5700 MHz according to the fourth embodiment of the present invention; and

FIG. 30E is a diagram of a vertical plane pattern of the third signal feed portion at a frequency of 5900 MHz according to the fourth embodiment of the present invention.

### DETAILED DESCRIPTION OF THE INVENTION

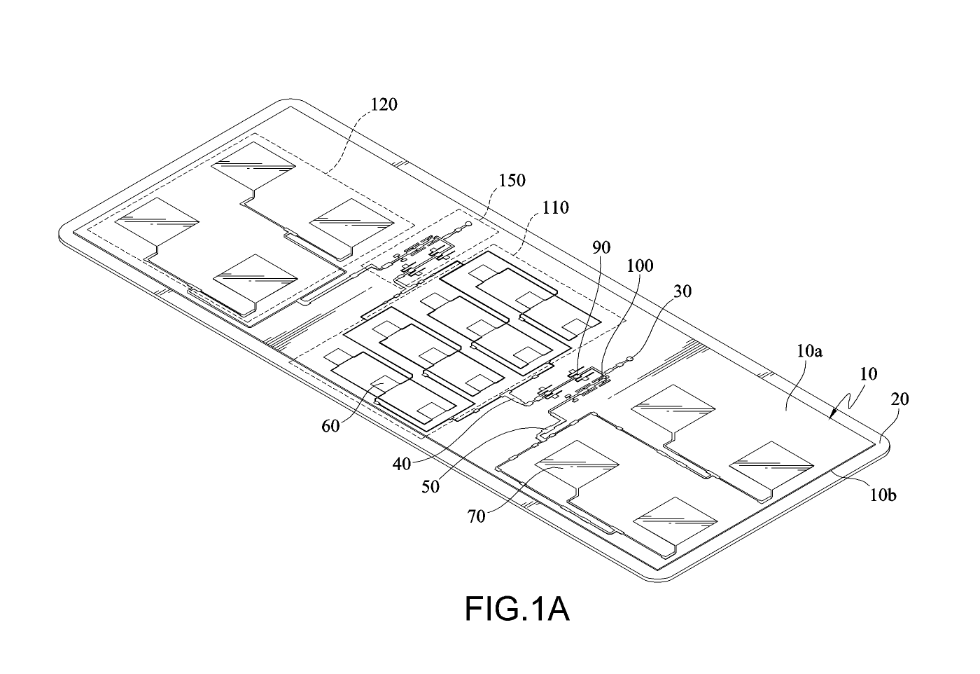

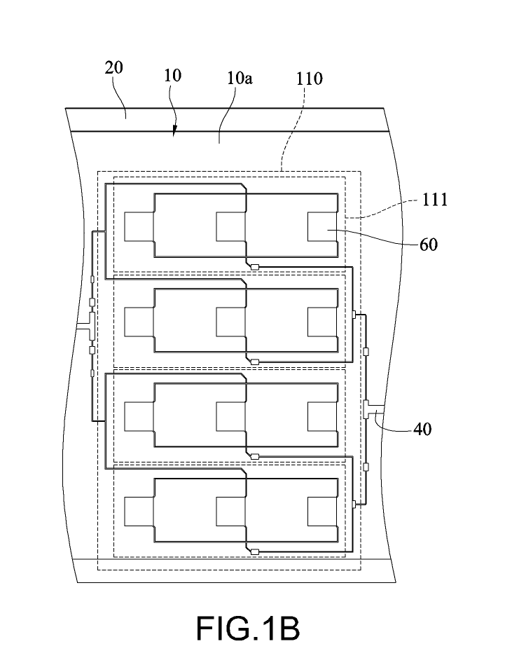

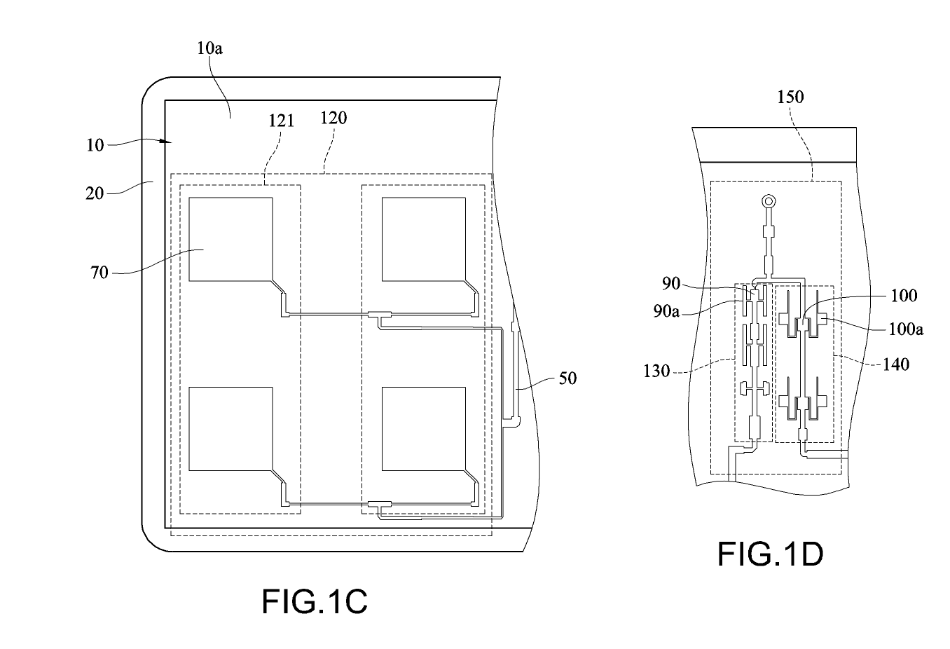

FIG. 1A is a schematic view of a first embodiment of the present invention. Referring to FIG. 1A, a dual-frequency antenna according to the first embodiment of the present invention includes a substrate 10, a ground layer 20, a plurality of signal feed portions 30, at least one first radiation portion 110, a plurality of second radiation portions 120, a plurality of first signal transmission lines 40, a plurality of second signal transmission lines 50, and a multiplexer 150.

The substrate 10 has a first surface 10a and a second surface 10b. The ground layer 20 is located on the second surface 10b.

The plurality of signal feed portions 30 is located on the first surface 10a.

The at least one first radiation portion 110 is located on the first surface 10a.

The plurality of second radiation portions 120 is located on the first surface 10a. The plurality of second radiation portions 120 and the at least one first radiation portion 110 have different radiation frequency bands and serially connected in a staggered manner.

The plurality of first signal transmission lines 40 is located on the first surface 10a. One end of each of the first signal transmission lines 40 is connected to one of the at least one first radiation portion 110, and the other end thereof is connected to one of the plurality of signal feed portions 30. Among the plurality of first signal transmission lines 40, two first signal transmission lines 40 are connected to the same first radiation portion 110 in a dual-polarized input manner.

The plurality of second signal transmission lines 50 is located on the first surface 10a. One end of each of the second signal transmission lines 50 is connected to one of the plurality of second radiation portions 120, and the other thereof is connected to one of the plurality of signal feed portions 30.

Among the plurality of second radiation portions 120 and the at least one first radiation portion 110 that are serially connected in a staggered manner, two radiation portions located on the two ends thereof are configured into a single-polarized input manner, and the other radiation portions are configured into a dual-polarized input manner.

The multiplexer 150 includes a plurality of first filters 130 and a plurality of second filters 140, and the multiplexer 150 is located on the first surface 10a.

The plurality of first filters 130 is respectively disposed on the plurality of first signal transmission lines 40, and each of the first filters 130 is electrically connected between one of the plurality of signal feed portions 30 and one of the at least one first radiation portion 110. The first filters 130 are used to filter out other frequency band signals except the first frequency band signals transferred by the signal feed portions 30, so as to prevent the other frequency band signals except the first frequency band signals from being transferred to the first radiation portion 110.

The plurality of second filters 140 is respectively disposed on the plurality of second signal transmission lines 50, and each of the second filters 140 is electrically connected between one of the plurality of signal feed portions 30 and one of the plurality of second radiation portions 120. The second filters 140 are used to filter out other frequency band signals except the second frequency band signals transferred by the signal feed portions 30, so as to prevent the other frequency band signals except the second frequency band signals from being transferred to the second radiation portions 120.

FIG. 1B is a schematic view of a first radiation portion. Referring to FIG. 1B, each first radiation portion 110 includes a plurality of first sub-radiation portions 111. Each two of the plurality of first sub-radiation portions 111 are connected in parallel and electrically connected to at least one of the plurality of first signal transmission lines 40. Each of the first sub-radiation portions 111 further includes a plurality of first radiation units 60. The plurality of first radiation units 60 are connected in parallel and electrically connected to at least one of the plurality of first signal transmission lines 40.

FIG. 1C is a schematic view of a second radiation portion. Referring to FIG. 1C, each of the second radiation portions 120 includes a plurality of second sub-radiation portions 121. Each two of the plurality of second sub-radiation portions 121 are connected in parallel and electrically connected to at least one of the plurality of second signal transmission lines 50. Each of the second sub-radiation portions 121 further includes a plurality of second radiation units 70. The plurality of second radiation units 70 are connected in parallel and electrically connected to at least one of the plurality of second signal transmission lines 50.

FIG. 1D is a schematic view of a multiplexer. Each of the first filters 130 includes a plurality of first filtering units 90. The plurality of first filtering units 90 is serially connected with each other in sequence. Each of the first filtering units 90 further includes two filtering portions 90a that are connected in parallel. The serially-connected first filtering units 90 are used to divide the first frequency band signal into a plurality of first sub frequency band signals, so as to avoid problems of severe signal noises or signal attenuation occurring at both ends of the frequency band of the first frequency band signal transferred by the first filter 130 with a single filtering unit.

Each of the second filters 140 includes a plurality of second filtering units 100. The plurality of second filtering units 100 are serially connected with each other in sequence. Each of the second filtering units 100 further includes two filtering portions 100a that are connected in parallel. The serially-connected second filtering units 100 are used to divide the second frequency band signal into a plurality of second sub frequency band signals, so as to avoid problems of severe signal noises or signal attenuation occurring at both ends of the frequency band of the second frequency band signal transferred by the second filter 140 with a single filtering unit.

The substrate 10 is generally a printed circuit board, and definitely, other types of boards are also available. Furthermore, the substrate 10 may be a rigid board or a flexible board, in which the rigid board is made of glass fiber or bakelite and the like and the flexible board is made of polyimide (PI) or polyethylene terephthalate (PET), and the like.

The ground layer 20 may be a metal layer formed on the second surface 10b of the substrate 10, or may be a metal plate connected to the second surface 10b. The metal plate is made of a conductive material such as Cu and Al.

The first radiation units 60 and the second radiation units 70 may be rectangular-shaped, which definitely may be round or finger shaped and the like. The first radiation units 60 are used to radiate signals at a frequency band of 2.4 GHz-2.5 GHz. The second radiation units 70 are used to radiate signals at a frequency band of 5.15 GHz-5.875 GHz.

According to this embodiment, the dual-frequency antenna includes a first radiation portion 110 and two second radiation portions 120 that are serially connected in a staggered manner. The first radiation portion 110 is formed by two first sub-radiation portions 111 that are connected in parallel, and each first sub-radiation portion 111 is formed by two first radiation units 60 that are connected in parallel. Each of the second radiation portions 120 is formed by four second sub-radiation portions 121 that are connected in parallel, and each of the second sub-radiation portions 121 is formed by three second radiation units 70 that are connected in parallel. One signal feed portion 30 is respectively disposed between the first radiation portion 110 and the second radiation portions 120. The signal feed portion 30 is connected to the second radiation portion 120 via a second signal transmission line 50, and the second signal transmission line 50 is provided with a second filter 140, for filtering out other frequency band signals except the second frequency band signals. The signal feed portion 30 is connected to the first radiation portion 110 via a first signal transmission line 40, and the first signal transmission line 40 is provided with a first filter 130, for filtering out other frequency band signals except the first frequency band signals. Since the first radiation portion 110 is located between two signal feed portions 30, the two first signal transmission lines 40 for connecting the two signal feed portions 30 to the first radiation portion 110 are respectively connected to two sides of the first radiation unit 60, so that the first radiation portion 110 is configured into a dual-polarized input mode, and the second radiation portions on two ends are respectively configured into a single-polarized input mode.

In the dual-frequency antenna according to this embodiment of the present invention, when signals with two different frequency bands are fed in by the signal feed portions 30, the two different frequency bands in the signals are respectively selected by the first filter 130 and the second filter 140, and then the two different frequency bands are transferred to radiation signals of the radiation portions corresponding to each frequency band. Therefore, through this embodiment, the dual-polarized multi-feed antenna with broadband and high gain features can be achieved.

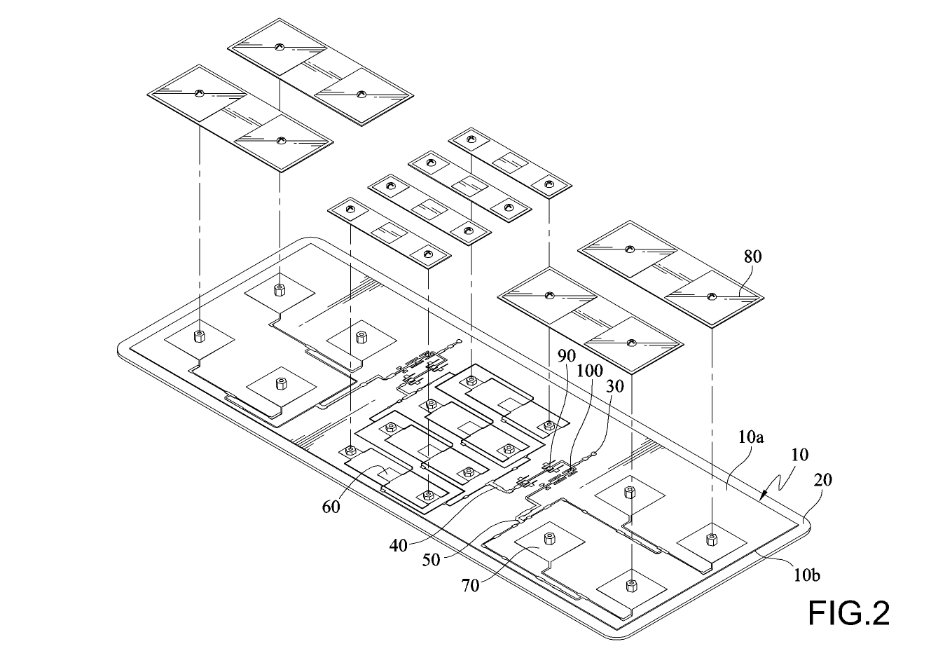

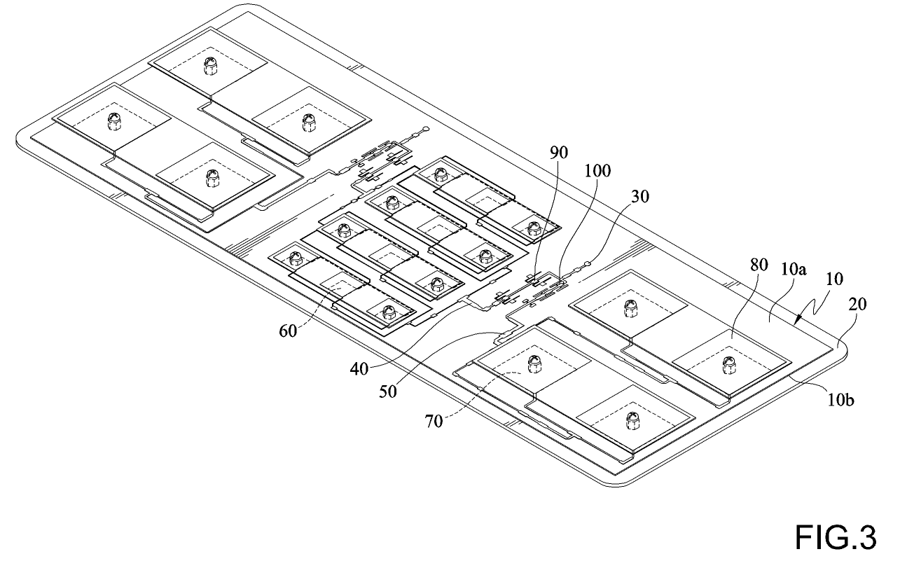

FIG. 2 is an exploded view of a second embodiment of the present invention. FIG. 3 is a schematic view of the second embodiment of the present invention. Referring to FIGS. 2 and 3, this embodiment is substantially the same as the above embodiment (the specific elements thereof can be obtained with reference to FIGS. 1A-1D). However, this embodiment further includes a plurality of metal layers 80. Each metal layer 80 is correspondingly disposed above one radiation portion of at least one first radiation portion 110 and a plurality of second radiation portions 120, and is electrically isolated from the at least one first radiation portion 110 and the plurality of second radiation portions 120, so as to couple the radiation signal corresponding to the radiation portion.

The plurality of metal layers 80 is correspondingly disposed above a plurality of first radiation units 60 and a plurality of second radiation units 70 one to one. The plurality of metal layers 80 is electrically isolated from the plurality of first radiation units 60 and the plurality of second radiation units 70, and shields each corresponding first radiation unit 60 and each corresponding second radiation unit 70, so as to couple a radiation signal of each corresponding first radiation unit 60 and each corresponding second radiation unit 70. Definitely, the plurality of metal layers 80 may be correspondingly disposed above the plurality of first radiation units 60 or the plurality of second radiation units 70 one to one.

The shape of the metal layers 80 may cover the shape and size of the radiation portions where the metal layers 80 are correspondingly coupled. The metal layers 80 are supported and isolated from the first radiation units 60 and the second radiation units 70 by a non-conductive material.

The dual-frequency antenna in this embodiment includes a first radiation portion 110 and two second radiation portions 120 that are serially connected in a staggered manner. The first radiation portion 110 is formed by two first sub-radiation portions 111 that are connected in parallel, and each of the first sub-radiation portions 111 is formed by two first radiation units 60 that are connected in parallel. Each of the second radiation portions 120 is formed by four second sub-radiation portions 121 that are connected in parallel, and each of the second sub-radiation portions 121 is formed by three second radiation units 70 that are connected in parallel. One signal feed portion 30 is respectively disposed between the first radiation portion 110 and the second radiation portions 120. The signal feed portion 30 is connected to the second radiation portion 120 via a second signal transmission line 50. The second signal transmission line 50 is provided with a second filter 140, for filtering out other frequency band signals except the second frequency band signals. The signal feed portion 30 is connected to the first radiation portion 110 via a first signal transmission line 40. The first signal transmission line 40 is provided with a first filter 130, for filtering out other frequency band signals except the first frequency band signals. Since the first radiation portion 110 is located between two signal feed portions 30, the two first signal transmission lines 40 used for connecting the two signal feed portions 30 to the first radiation portion 110 are respectively connected to two sides of the first radiation unit 60, so that the first radiation portion 110 is configured into a dual-polarized input mode, and the second radiation portions at two ends thereof are configured into a single-polarized input mode. The plurality of metal layers 80 is respectively coupled to the corresponding radiation portion.

In the dual-frequency antenna according to the present invention, when signals with two different frequency bands are fed in by the signal feed portions 30, the two different frequency bands in the signals are respectively selected by the first filter 130 and the second filter 140, and then the two different frequency bands are transferred to radiation signals of the radiation portions corresponding to each frequency band. Through coupling the metal layers 80 corresponding to and covering each radiation portion, a coupling antenna takes the air between the radiation portions and the metal layers of the antenna as the media, so as to offer a relatively large space for combining the signal transmission lines and relevant circuits, thereby realizing a dual-frequency, dual-polarized, and dual-feed antenna with broadband and high gain features.

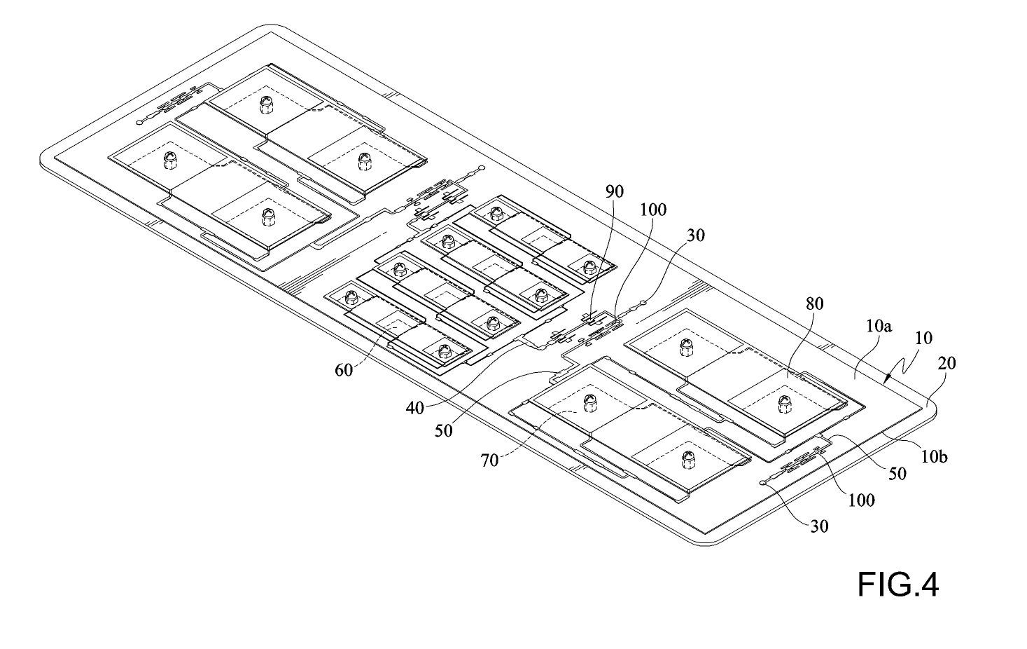

FIG. 4 is a schematic view of a third embodiment of the present invention. Referring to FIG. 4, this embodiment is substantially the same as the above embodiments (the specific elements thereof can be obtained with reference to FIGS. 1A-1D and FIGS. 2-3). In this embodiment, among the plurality of second radiation portions 120 and the at least one first radiation portion 110 that are serially connected in a staggered manner, all the radiation portions are configured into a dual-polarized input mode. Alternatively, among the plurality of second radiation portions 120 and the at least one first radiation portion 110 that are serially connected in a staggered manner, one of the two radiation portions located at two ends is configured into a single-polarized input mode, and the other radiation portions are configured into the dual-polarized input mode.

In the dual-frequency antenna in this embodiment, the second radiation portions 120 located at two ends are externally connected to a signal feed portion 30 respectively. Definitely, merely one second radiation portion 120 at one end may be externally connected to a signal feed portion 30. A second signal transmission line 50 is used to connect the second radiation portion 120 to the signal feed portion 30, and the second signal transmission line 50 is provided with a second filter 140. Therefore, at least three signal feed portions 30 are provided in this embodiment.

The dual-frequency antenna according to this embodiment includes a first radiation portion 110 and two second radiation portions 120 that are serially connected in a staggered manner. The first radiation portion 110 is formed by two first sub-radiation portions 111 that are connected in parallel, and each of the first sub-radiation portions 111 is formed by two first radiation units 60 that are connected in parallel. Each of the second radiation portions 120 is formed by four second sub-radiation portions 121 that are connected in parallel, and each of the second sub-radiation portions 121 is formed by three second radiation units 70 that are connected in parallel. One signal feed portion 30 is respectively disposed between the first radiation portion 110 and the second radiation portions 120 and externally disposed at the two second radiation portions 120 located at the two ends. The signal feed portion 30 is connected to the second radiation portion 120 via a second signal transmission line 50. The second signal transmission line 50 is provided with a second filter 140, for filtering out other frequency band signals except the second frequency band signals. The signal feed portion 30 is connected to the first radiation portion 110 via a first signal transmission line 40. The first signal transmission line 40 is provided with a first filter 130, for filtering out other frequency band signals except the first frequency band signals. Since the first radiation portion 110 is located between two signal feed portions 30, the two first signal transmission lines 40 used for connecting the two signal feed portions 30 to the first radiation portion 110 are respectively connected to two sides of the first radiation unit 60, so that the first radiation portion 110 is configured into a dual-polarized input mode. Since the second radiation portion 120 is located between two signal feed portions 30, the two second signal transmission lines 50 used for connecting the two signal feed portions 30 to the second radiation portion 120 are respectively connected to two sides of the second radiation unit 70, so that the second radiation portion is configured into a dual-polarized input mode. The plurality of metal layers 80 is respectively coupled to the corresponding radiation portion.

In the dual-frequency antenna according to the present invention, when signals with two different frequency bands are fed in by the signal feed portions 30, the two different frequency bands in the signals are respectively selected by the first filter 130 and the second filter 140, and then the two different frequency bands are transferred to radiation signals of the radiation portions corresponding to each frequency band. Through coupling the metal layers 80 corresponding to and covering each radiation portion, a coupling antenna takes the air between the radiation portions and the metal layers of the antenna as the media, so as to offer a relatively large space for combining the signal transmission lines and relevant circuits, thereby achieving the broadband and high gain features.

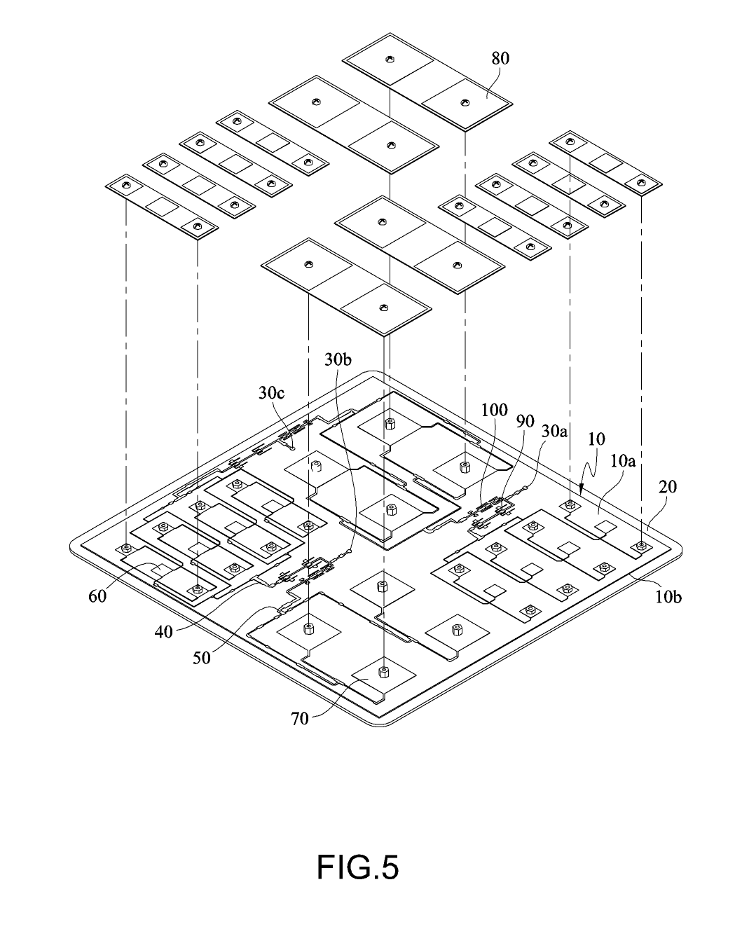

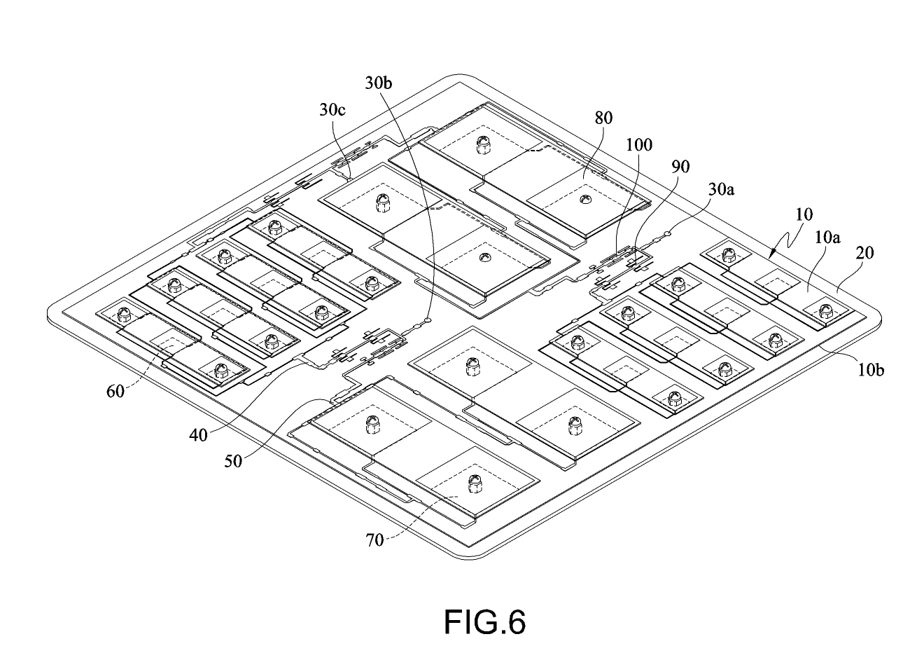

FIG. 5 is an exploded view of a fourth embodiment of the present invention. FIG. 6 is a schematic view of the fourth embodiment of the present invention. Referring to FIGS. 5 and 6, this embodiment is substantially the same as the above embodiments (the specific elements thereof can be obtained with reference to FIGS. 1A-1D, FIGS. 2-3, and FIG. 4). Besides being serially connected in a staggered manner and extended along the first surface 10a of the substrate 10 in a one-dimensional direction, a plurality of first radiation portions 110 and a plurality of second radiation portion may be further serially connected in a staggered manner and meanwhile arranged on the first surface 10a of the substrate 10 in a [symbol] -shaped configuration (i.e., extending along a two-dimensional direction), so as to reduce the size of the dual-frequency antenna. The dual-frequency antenna in this embodiment includes two first radiation portions 110 and two second radiation portions 120 that are serially connected in a staggered manner. Each of the first radiation portions 110 is formed by two first sub-radiation portions 111 that are connected in parallel, and each of the first sub-radiation portions 111 is formed by two first radiation units 60 that are connected in parallel. Each of the second radiation portions 120 is formed by four second sub-radiation portions 121 that are connected in parallel, and each of the second sub-radiation portions 121 is formed by three second radiation units 70 that are connected in parallel. A first signal feed portion 30a, a second signal feed portion 30b, and a third signal feed portion 30c are respectively disposed between the first radiation portions 110 and the second radiation portions 120. The first signal feed portion 30a, the third signal feed portion 30c, and the second radiation portion 120 are connected with each other via a second signal transmission line 50. The second signal transmission line 50 is provided with a second filter 140, for filtering out other frequency band signals except the second frequency band signals. The second signal feed portion 30b, the third signal feed portion 30c, and the first radiation portion 110 are connected with each other via a first signal transmission line 40. The first signal transmission line 40 is provided with a first filter 130, for filtering out the other frequency band signals except the first frequency band signals. As for the first radiation portion 110 between the second signal feed portion 30b and the third signal feed portion 30c, the two first signal transmission lines 40 for connecting the second signal feed portion 30b and the third signal feed portion 30c to the first radiation portion 110 are respectively connected to two sides of the first radiation unit 60, so that the first radiation portion 110 between the second signal feed portion 30b and the third signal feed portion 30c is configured into a dual-polarized input mode. As for the second radiation portion 120 between the first signal feed portion 30a and the third signal feed portion 30c, the two second signal transmission lines 50 for connecting the first signal feed portion 30a and the third signal feed portion 30c to the second radiation portion 120 are respectively connected to two sides of the second radiation unit 70, so that the second radiation portion 120 between the first signal feed portion 30a and the third signal feed portion 30c is configured into a dual-polarized input mode. The first radiation portion 110 and the second radiation portion 120 at the two ends are configured into a single-polarized input mode. A plurality of metal layers 80 is respectively coupled to the corresponding radiation portion.

In the dual-frequency antenna according to the present invention, when signals with two different frequency bands are fed in through the first signal feed portion 30a, the second signal feed portion 30b, and the third signal feed portion 30c, the two different frequency bands of the signals are respectively selected by the first filter 130 and the second filter 140, and then the two different frequency bands are transferred to radiation signals of the radiation portions corresponding to each frequency band. Through coupling the metal layers 80 corresponding to and covering each radiation portion, a coupling antenna takes the air between the radiation portions and the metal layers 80 of the antenna as the media, so as to offer a relatively large space for combining the signal transmission lines and relevant circuits, thereby realizing a dual-frequency, dual-polarized, and triple-feed antenna with broadband and high gain features.

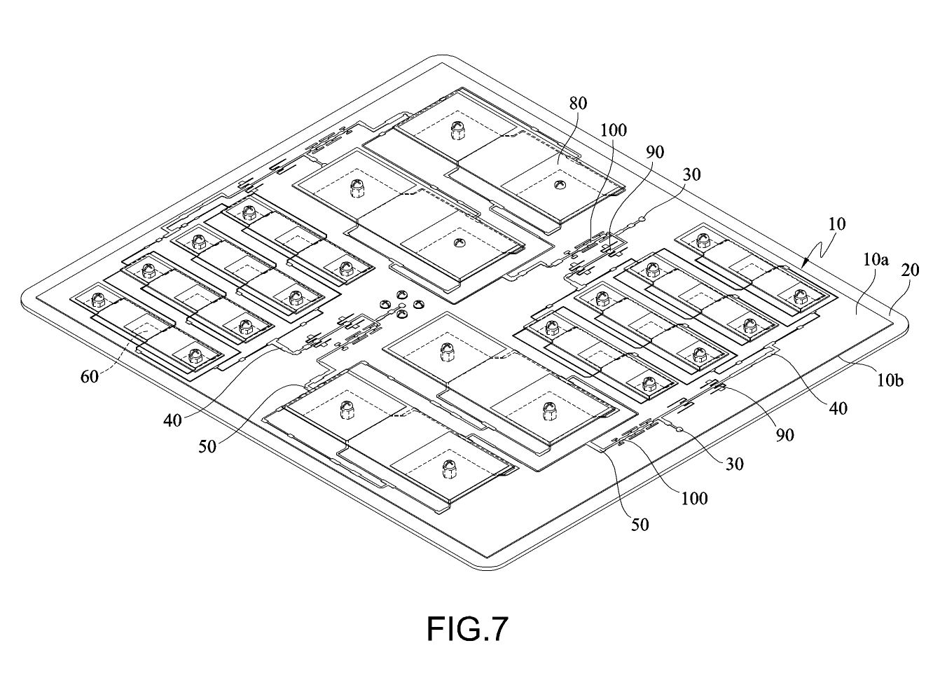

FIG. 7 is a schematic view of a fifth embodiment of the present invention. Referring to FIG. 7, this embodiment is substantially the same as the above embodiments (the specific elements thereof can be obtained with reference to FIGS. 1A-1D, and FIGS. 2-6). In this embodiment, among a plurality of second radiation portions 120 and a plurality of first radiation portions 110 that are serially connected in a staggered manner, all the radiation portions are configured into a dual-polarized input mode. In this embodiment, the first radiation portion 110 and the second radiation portion 120 at two ends of the dual-frequency antenna are both connected to one signal feed portion 30. The second radiation portion 120 is connected to the signal feed portion 30 via a second signal transmission line 50. The second signal transmission line 50 is provided with a second filter 140. The first radiation portion 110 is connected to the signal feed portion 30 via a first signal transmission line 40. The first signal transmission line 40 is provided with a first filter 130. Therefore, at least three signal feed portions 30 are provided in this embodiment.

The dual-frequency antenna in this embodiment includes two first radiation portions 110 and two second radiation portions 120 that are serially connected in a staggered manner. Each of the first radiation portions 110 is formed by two first sub-radiation portions 111 that are connected in parallel, and each of the first sub-radiation portions 111 is formed by two first radiation units 60 that are connected in parallel. Each of the second radiation portions 120 is formed by four second sub-radiation portions 121 that are connected in parallel, and each of the second sub-radiation portions 121 is formed by three second radiation units 70 that are connected in parallel. One signal feed portion 30 is respectively disposed between the first radiation portions 110 and the second radiation portions 120. The signal feed portion 30 is connected to the second radiation portion 120 via a second signal transmission line 50. The second signal transmission line 50 is provided with a second filter 140, for filtering out other frequency band signals except the second frequency band signals. The signal feed portion 30 is connected to the first radiation portion 110 via a first signal transmission line 40. The first signal transmission line 40 is provided with a first filter 130, for filtering out other frequency band signals except the first frequency band signals. As for the first radiation portion 110 between the two signal feed portions 30, the two first signal transmission lines 40 for connecting the two signal feed portions 30 to the first radiation portion 110 are respectively connected to two sides of the first radiation unit 60, so that the first radiation portion 110 between the two signal feed portions 30 is configured into a dual-polarized input mode. As for the second radiation portion 120 between the two signal feed portions 30, the two second signal transmission lines 50 for connecting the two signal feed portions 30 to the second radiation portion 120 are respectively connected to two sides of the second radiation unit 70, so that the second radiation portion 120 between the two signal feed portions 30 are configured into a dual-polarized input mode. A plurality of metal layers 80 is respectively coupled to the corresponding radiation portion.

Furthermore, besides taking the above two signal feed portions 30 as the architecture for illustration, a dual-frequency antenna with three signal feed portions 30 (as shown in FIGS. 5 and 6) or a dual-frequency antenna with more than four signal feed portions 30 (as shown in FIG. 7) may also be constructed according to the concept of the present invention.

In the dual-frequency antenna according to the present invention, when signals with two different frequency bands are fed in by the signal feed portions 30, the two different frequency bands of the signals are selected by the first filter 130 and the second filter 140, and then the two different frequency bands are transferred to radiation signals of the radiation portions corresponding to each frequency band. Through coupling the metal layers 80 corresponding to and covering each radiation portion, a coupling antenna takes an the between the radiation portions and the metal layers 80 of the antenna as the media, so as to offer a relatively large space for combining the signal transmission lines and relevant circuits, thereby realizing a dual-frequency, dual-polarized, and quintuple-feed antenna with broadband and high gain features.

During the design and manufacturing process, the dual-frequency antenna shall be tested by utilizing an anechoic chamber, in which a wall surface made of metals is used to isolate from the interferences caused by external signals. Inside the chamber, electromagnetic-wave absorbent materials are adhered on the wall to reduce the reflection energy inside the chamber. When performing the measurement, a near-field distribution of the electromagnetic wave parameters (such as amplitude and phase) radiated by an antenna under test (AUT) is detected by a receiving scanning probe (in the embodiments of the present invention, the distance between the AUT and the receiving scanning probe is 5.5 m, and the distance between the AUT and the ground is 2 m). The scanning may be performed in manner of a plane, a cylindrical surface, or a spherical surface. These RF (or microwave) signals are transferred to a vector network analyzer (VNA) in an electric manner via a coaxial cable, so as to obtain relevant data. After the data undergoes rear end processing such as the probe radiation pattern correct and the Fourier transformation, the desired radiation (far-field) pattern of the AUT may thus be obtained.

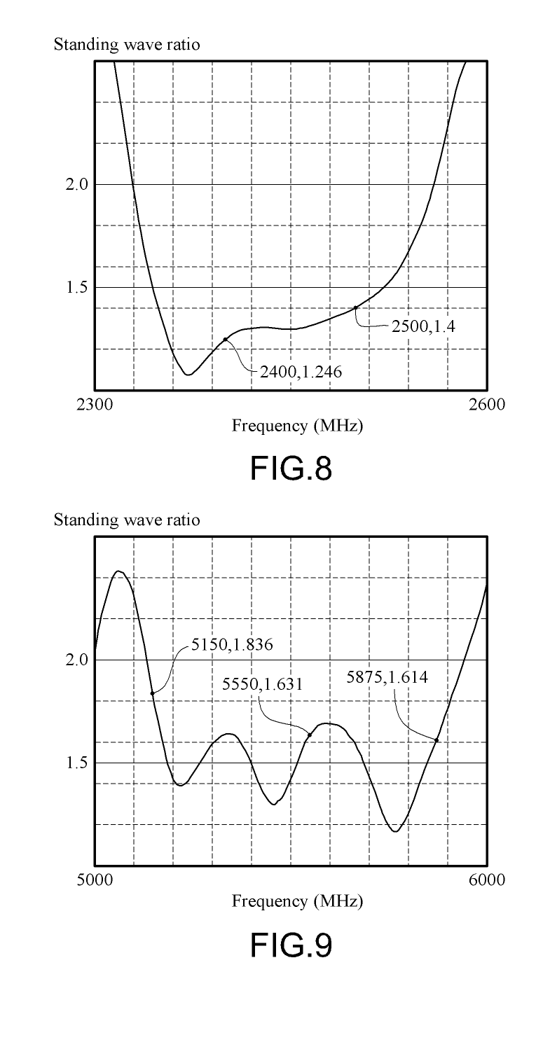

FIG. 8 is a measurement diagram of a standing wave ratio of a first signal feed portion at a frequency of 2.4 GHz-2.5 GHz according to the fourth embodiment of the present invention. Referring to FIG. 8, it can be seen that, the standing wave ratio is maintained below 1.5 at the frequency of 2.4 GHz-2.5 GHz.

FIG. 9 is a measurement diagram of a standing wave ratio of the first signal feed portion at a frequency of 5.15 GHz-5.875 GHz according to the fourth embodiment of the present invention. Referring to FIG. 9, it can be seen that, the standing wave ratio is maintained below 2 at the frequency of 5.15 GHz-5.875 GHz.

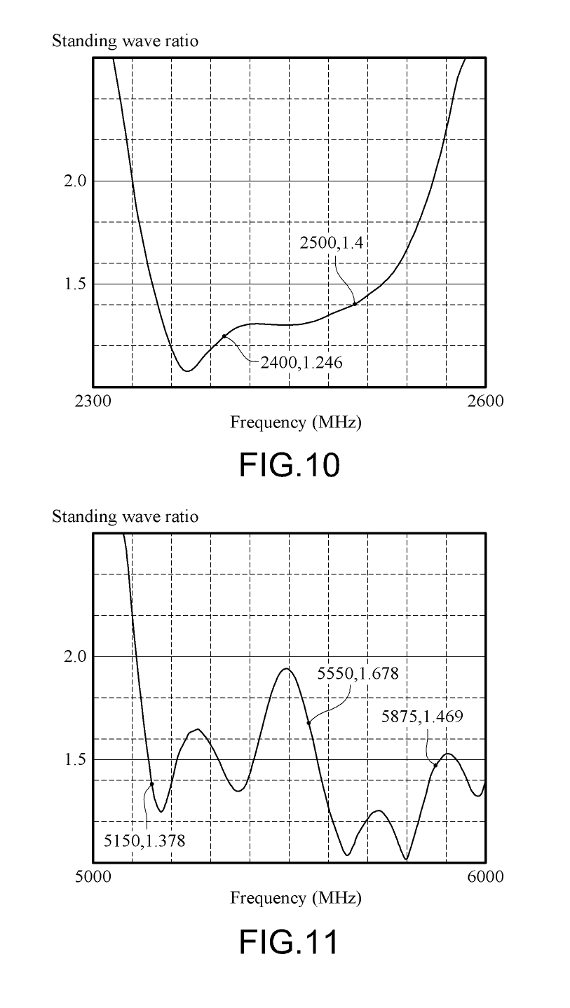

FIG. 10 is a measurement diagram of a standing wave ratio of a second signal feed portion at a frequency of 2.4 GHz-2.5 GHz according to the fourth embodiment of the present invention. Referring to FIG. 10, it can be seen that, the standing wave ratio is maintained below 1.5 at the frequency of 2.4 GHz-2.5 GHz.

FIG. 11 is a measurement diagram of a standing wave ratio of the second signal feed portion at a frequency of 5.15 GHz-5.875 GHz according to the fourth embodiment of the present invention. Referring to FIG. 11, it can be seen that, the standing wave ratio is maintained below 2 at the frequency of 5.15 GHz-5.875 GHz.

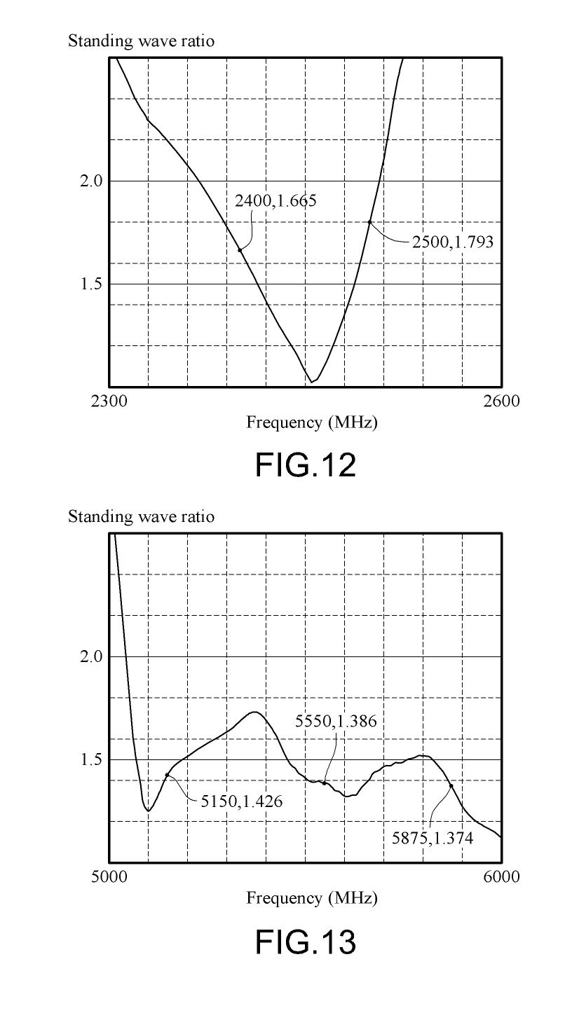

FIG. 12 is a measurement diagram of a standing wave ratio of a third signal feed portion at a frequency of 2.4 GHz-2.5 GHz according to the fourth embodiment of the present invention. Referring to FIG. 12, it can be seen that the standing wave ratio is maintained below 2 at the frequency of 2.4 GHz-2.5 GHz.

FIG. 13 is a measurement diagram of a standing wave ratio of the third signal feed portion at a frequency of 5.15 GHz-5.875 GHz according to the fourth embodiment of the present invention. Referring to FIG. 13, it can be seen that, the standing wave ratio is maintained below 2 at the frequency 5.15 GHz-5.875 GHz.

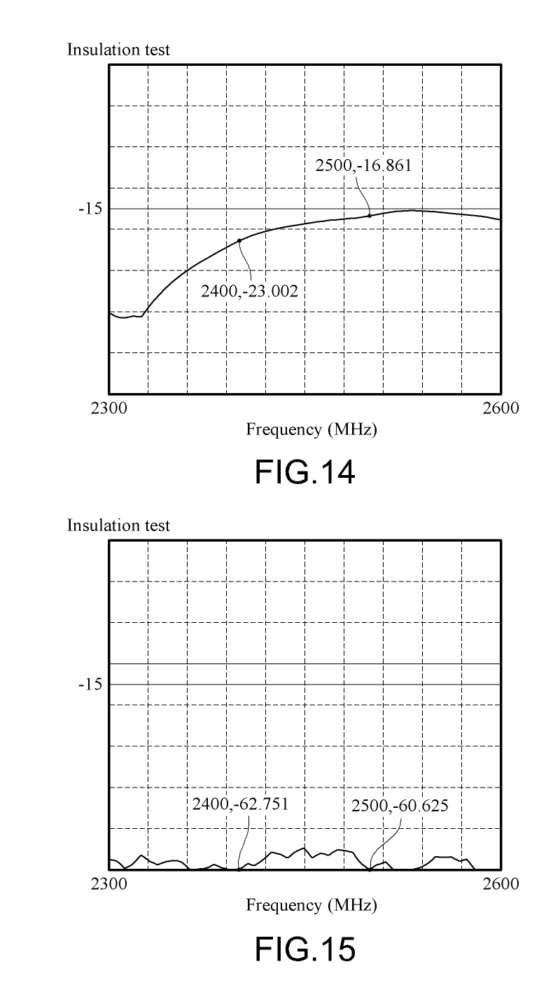

FIG. 14 is an insulation measurement diagram of the first signal feed portion and the second signal feed portion at a frequency of 2.4 GHz-2.5 GHz according to the fourth embodiment of the present invention. Referring to FIG. 14, it can be seen that, an insulation value is maintained below 15 dB at the frequency of 2.4 GHz-2.5 GHz.

FIG. 15 is an insulation measurement diagram of the second signal feed portion and the third signal feed portion at a frequency of 2.4 GHz-2.5 GHz according to the fourth embodiment of the present invention. Referring to FIG. 15, it can be seen that, the insulation value is maintained below 15 dB at the frequency of 2.4 GHz-2.5 GHz.

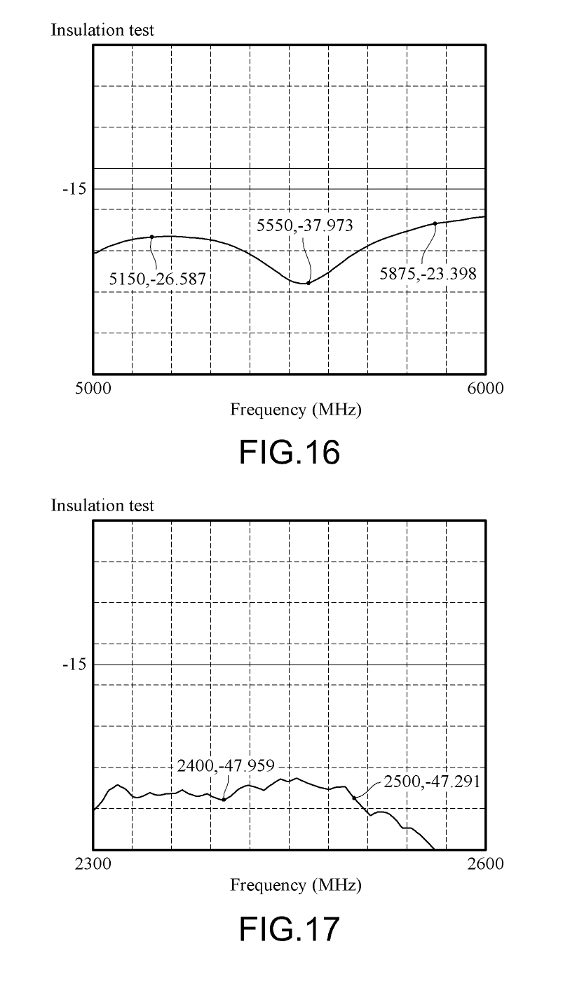

FIG. 16 is an insulation measurement diagram of the second signal feed portion and the third signal feed portion at a frequency of 5.15 GHz-5.875 GHz according to the fourth embodiment of the present invention. Referring to FIG. 16, it can be seen that the insulation value is maintained below 15 dB at the frequency of 5.15 GHz-5.875 GHz.

FIG. 17 is an insulation measurement diagram of the first signal feed portion and the third signal feed portion at the frequency of 2.4 GHz-2.5 GHz according to the fourth embodiment of the present invention. Referring to FIG. 17, it can be seen that, the insulation value is maintained below 15 at the frequency of 2.4 GHz-2.5 GHz.

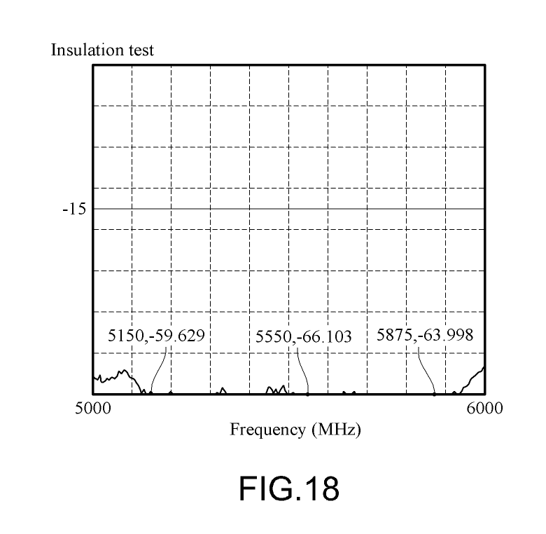

FIG. 18 is an insulation measurement diagram of the first signal feed portion and the third signal feed portion at a frequency of 5.15 GHz-5.875 GHz according to the fourth embodiment of the present invention. Referring to FIG. 18, it can be seen that, the insulation value is maintained below 15 at the frequency of 5.15 GHz-5.875 GHz.

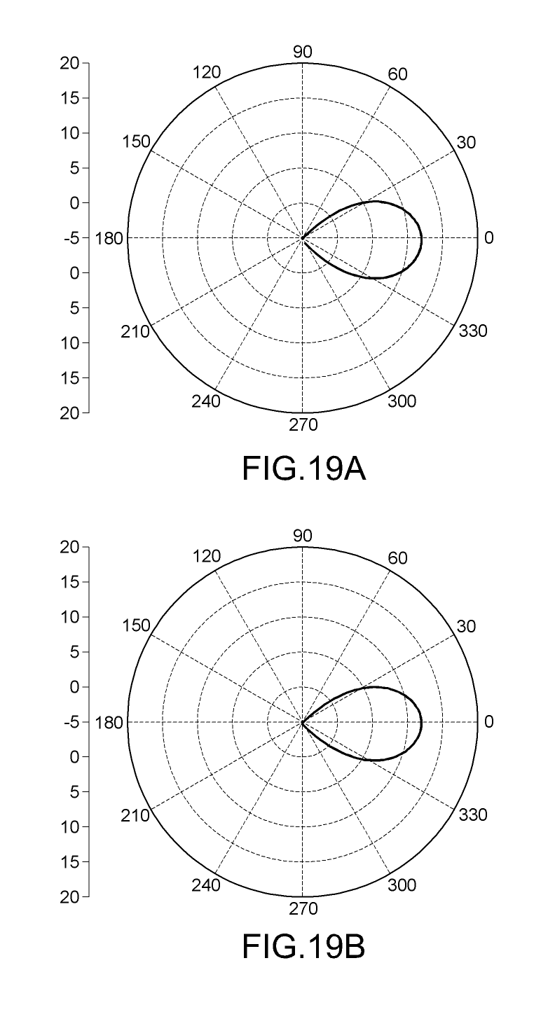

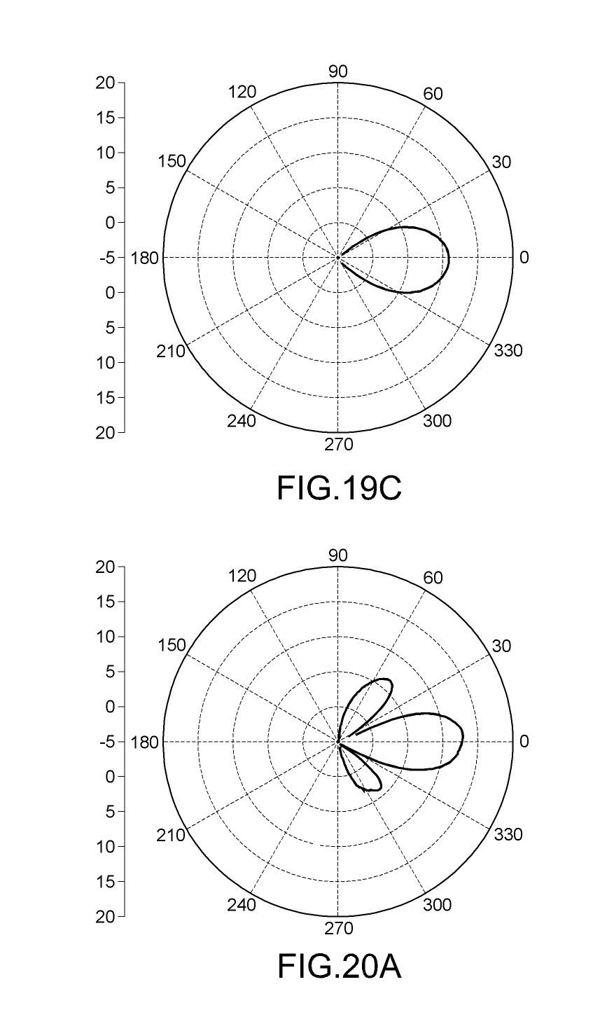

FIGS. 19A, 19B, and 19C are respectively diagrams of horizontal plane patterns of the first signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

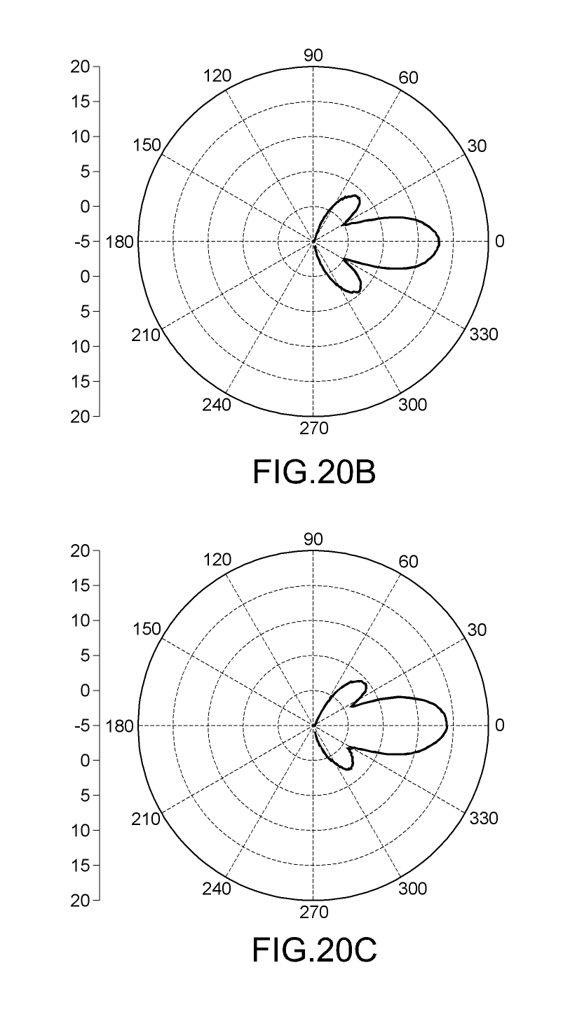

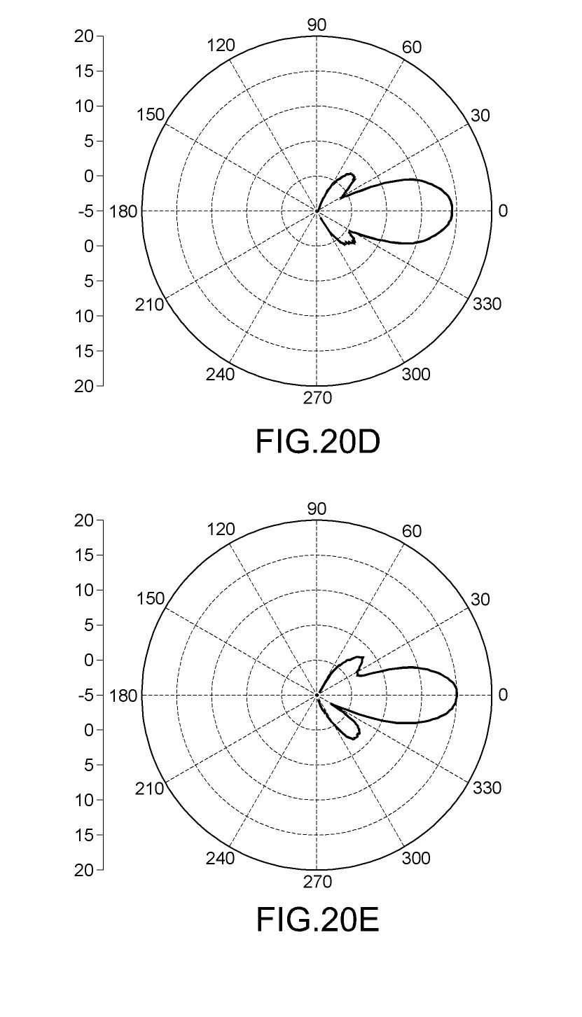

FIGS. 20A, 20B, 20C, 20D, and 20E are respectively diagrams of horizontal plane patterns of the first signal feed portion at frequencies of 5100 MHz, 5300 MHz, 5500 MHz, 5700 MHz, and 5900 MHz according to the fourth embodiment of the present invention, which are respectively tested at the frequencies of 51100 MHz, 5300 MHz, 5500 MHz, 5700 MHz, and 5900 MHz.

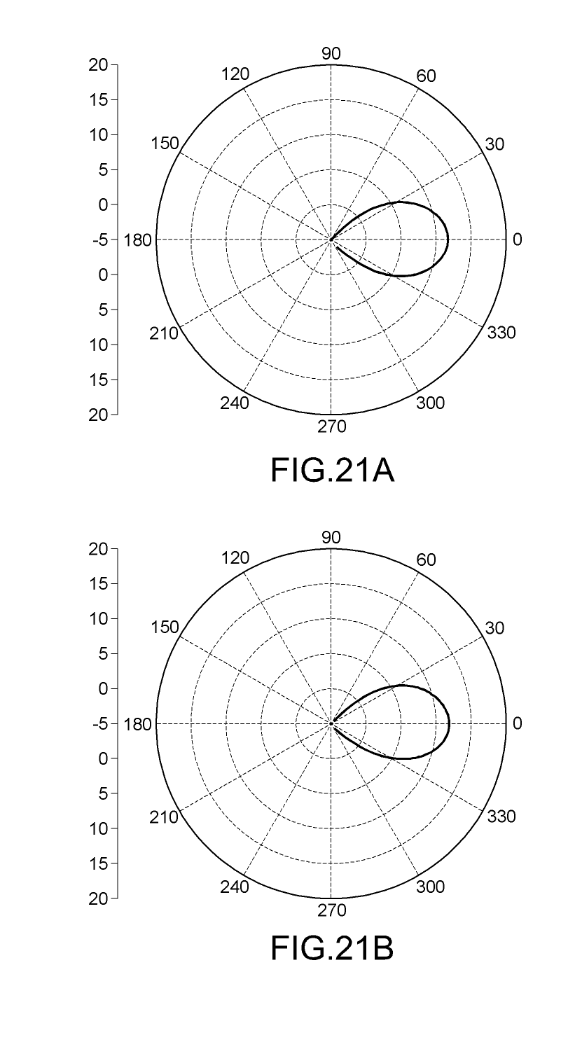

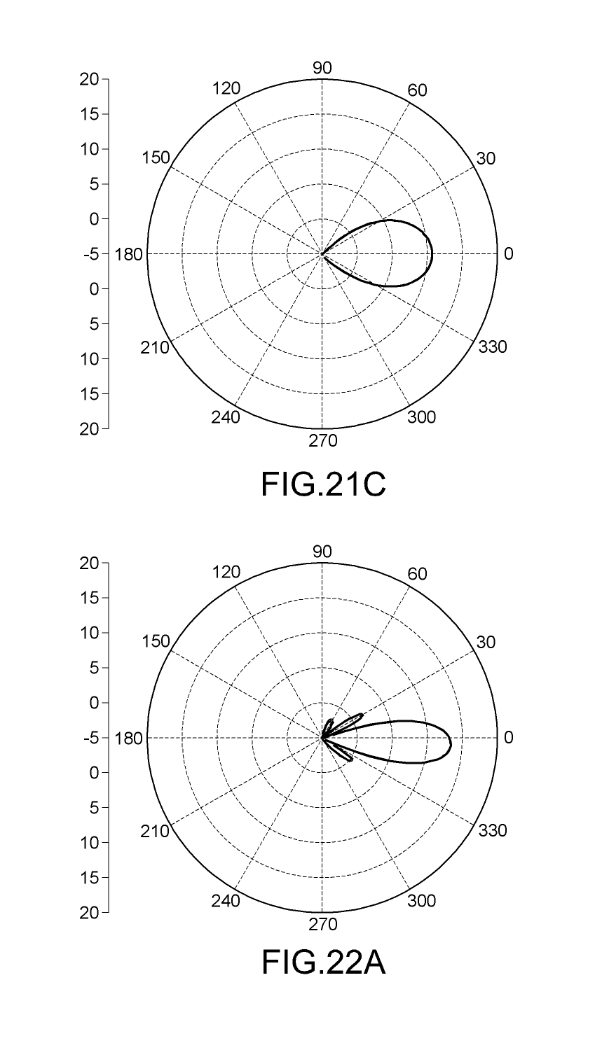

FIGS. 21A, 21B, and 21C are respectively diagrams of vertical plane patterns of the first signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

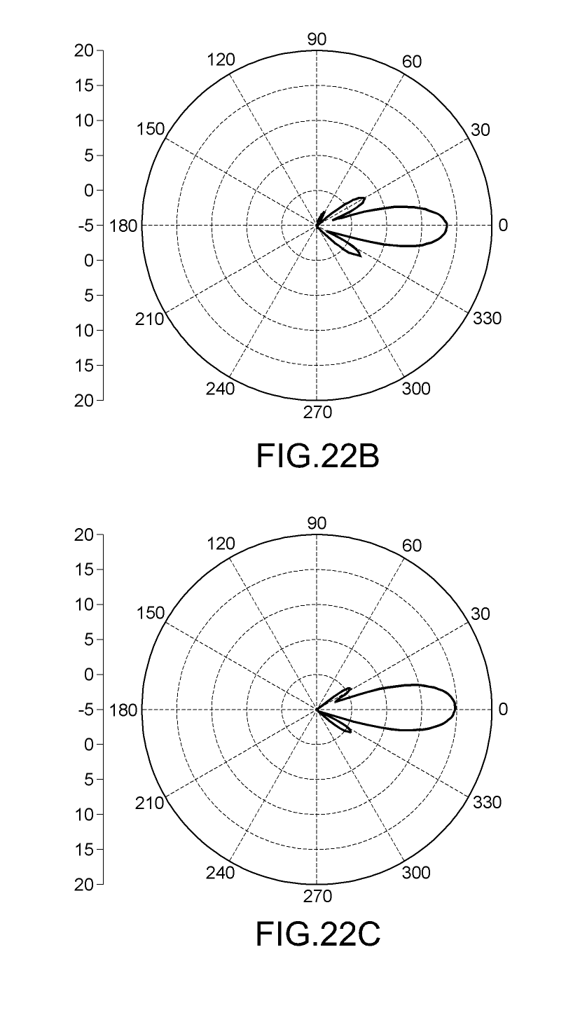

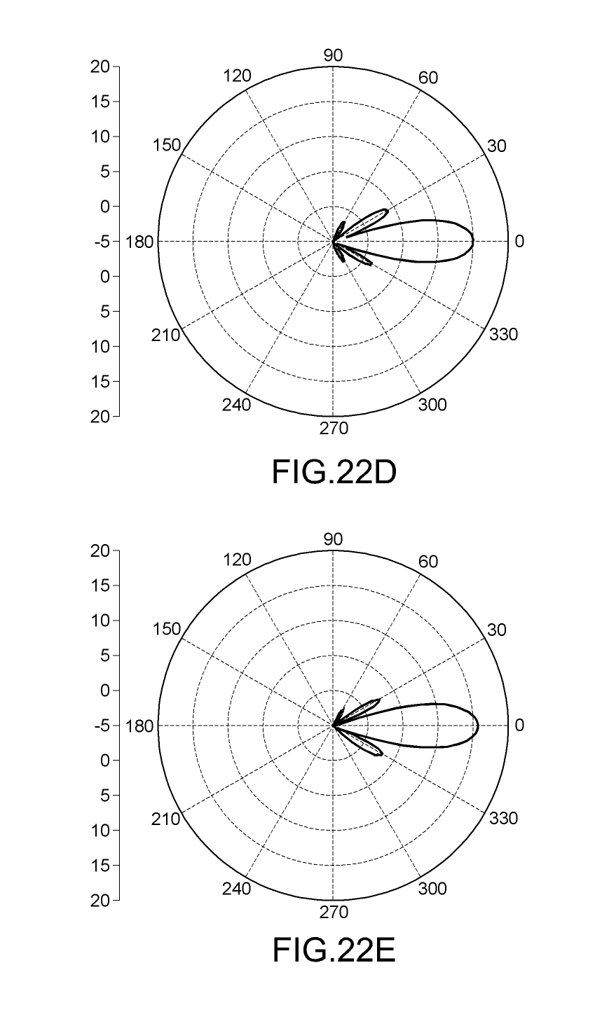

FIGS. 22A, 22B, 22C, 22D, and 22E are respectively diagrams of vertical plane patterns of the first signal feed portion at frequencies of 5100 MHz, 5300 MHz, 5500 MHz, 5700 MHz, and 5900 MHz according to the fourth embodiment of the present invention, which are respectively tested at the frequencies of 5100 MHz, 5300 MHz, 5500 MHz, 5700 MHz, and 5900 MHz.

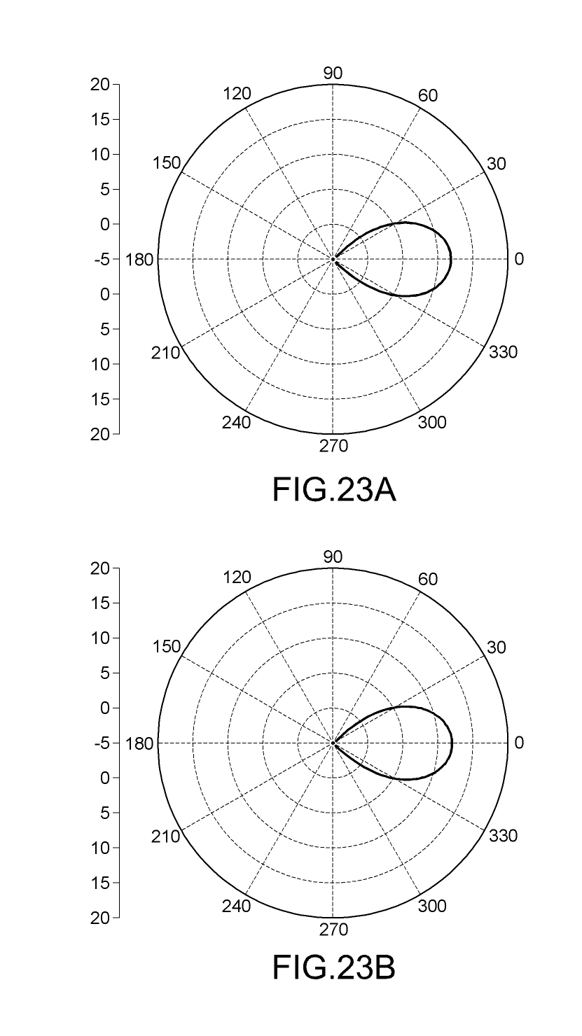

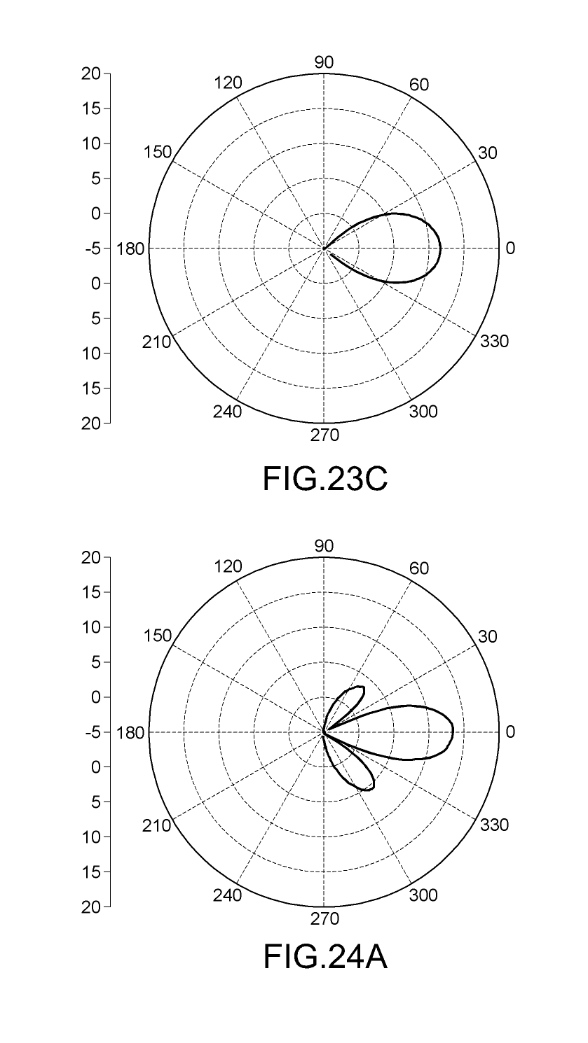

FIGS. 23A, 23B, and 23C are respectively diagrams of horizontal plane patterns of the second signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

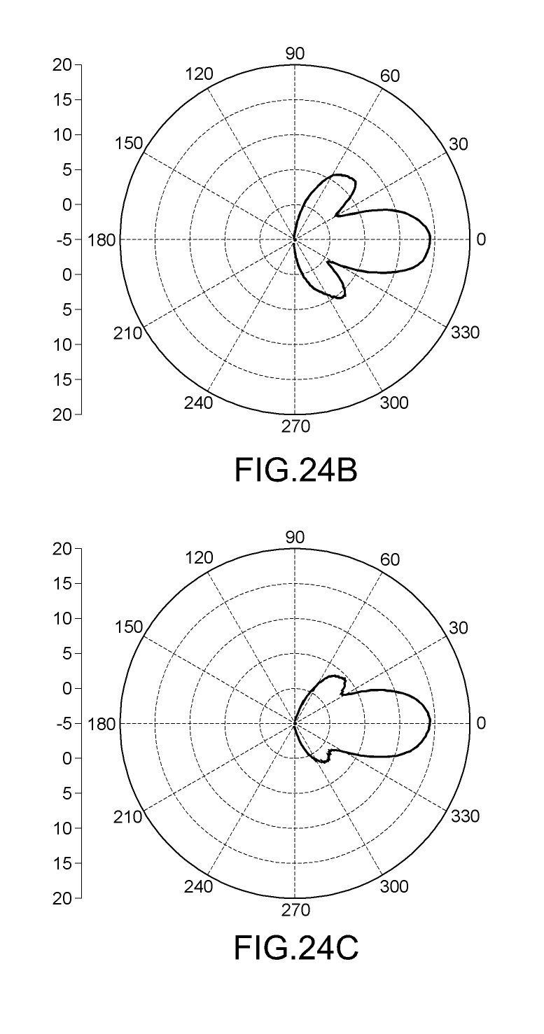

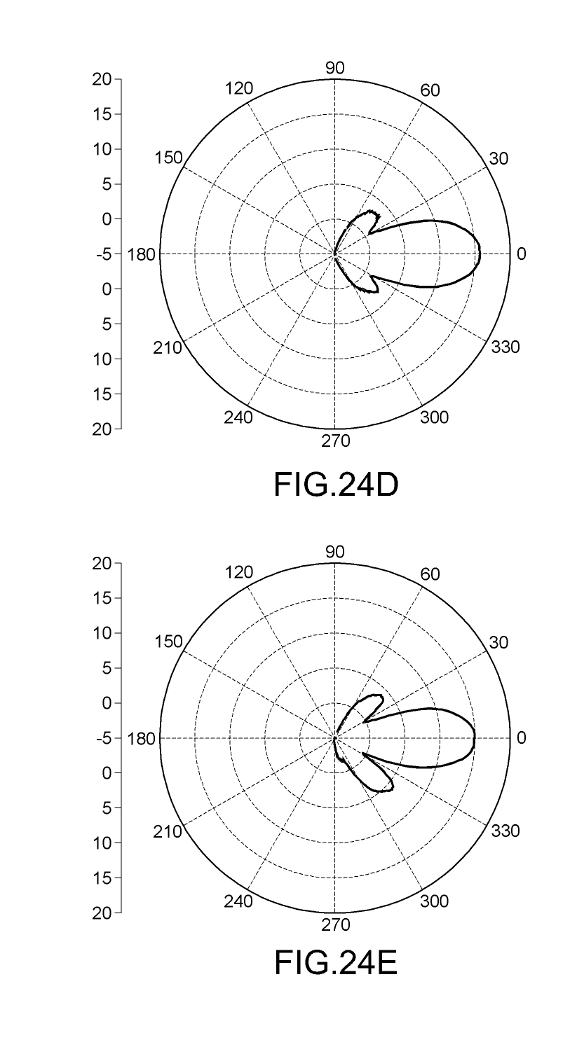

FIGS. 24A, 24B, 24C, 24D, and 24E are respectively diagrams of horizontal plane patterns of the second signal feed portion at frequencies of 5100 MHz, 5300 MHz, 5500 MHz, 5700 MHz, and 5900 MHz according to the fourth embodiment of the present invention, which are respectively tested at the frequencies of 5100 MHz, 5300 MHz, 5500 MHz, 5700 MHz, and 5900 MHz.

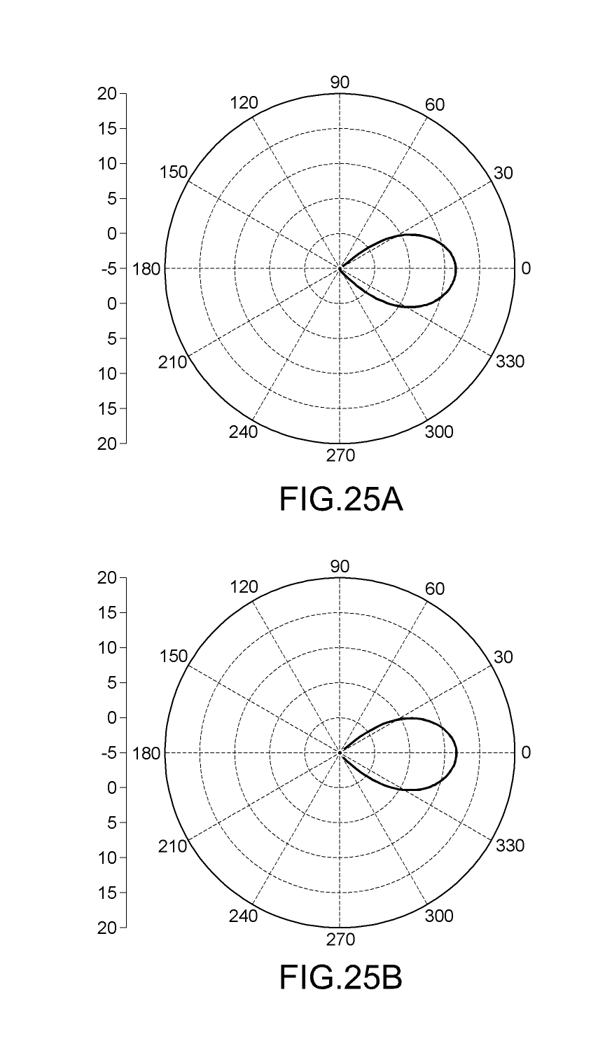

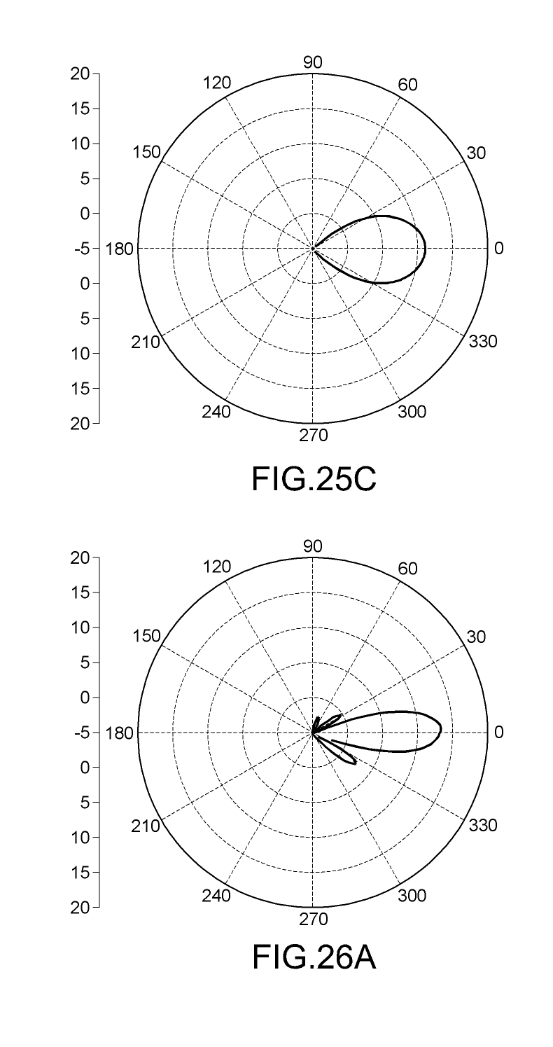

FIGS. 25A, 25B, and 25C are respectively diagrams of vertical plane patterns of the second signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

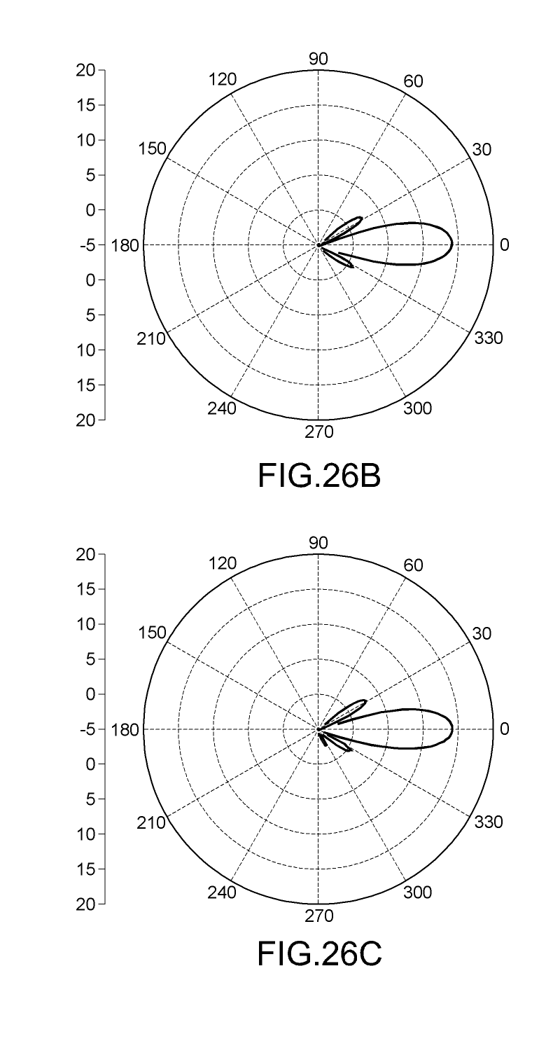

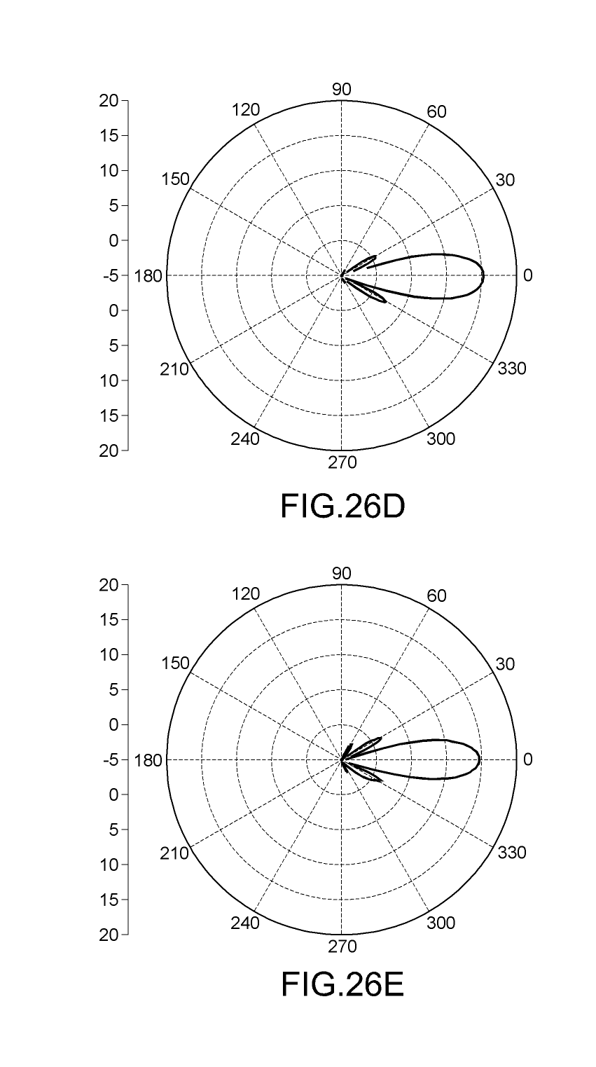

FIGS. 26A, 26B, 26C, 26D, and 26E are respectively diagrams of vertical plane patterns of the second signal feed portion at frequencies of 5100 MHz, 5300 MHz, 5500 MHz, 5700 MHz, and 5900 MHz according to the fourth embodiment of the present invention, which are respectively tested at the frequencies of 5100 MHz, 5300 MHz, 5500 MHz, 5700 MHz, and 5900 MHz.

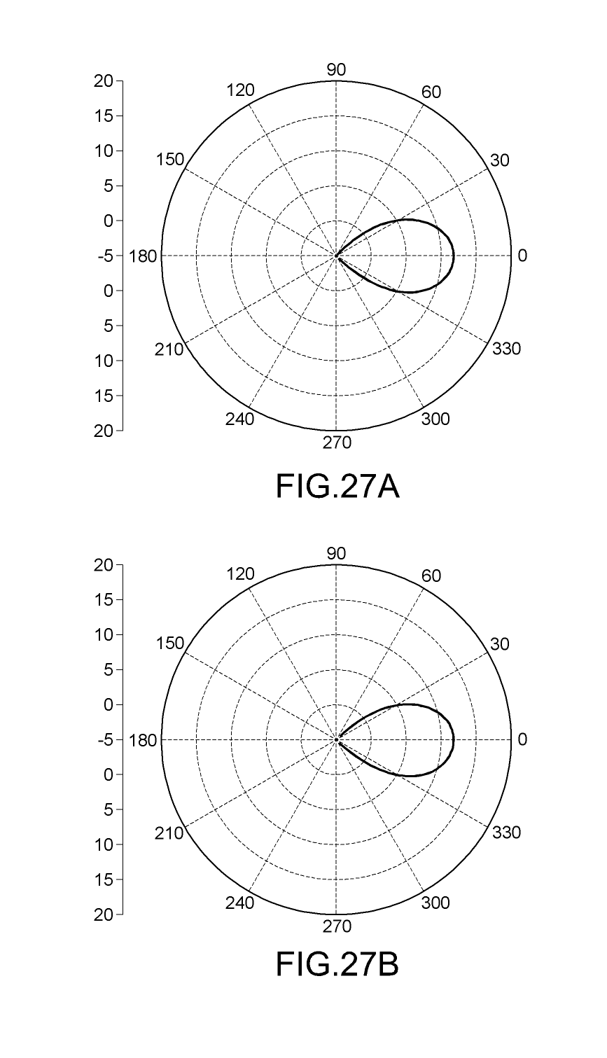

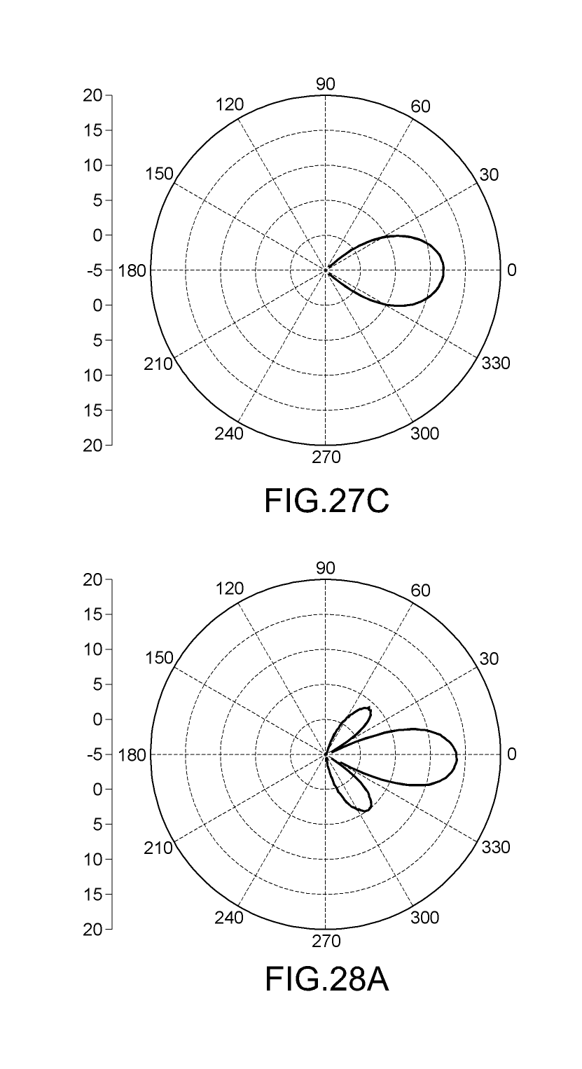

FIGS. 27A, 27B, and 27C are respectively diagrams of horizontal plane patterns of the third signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

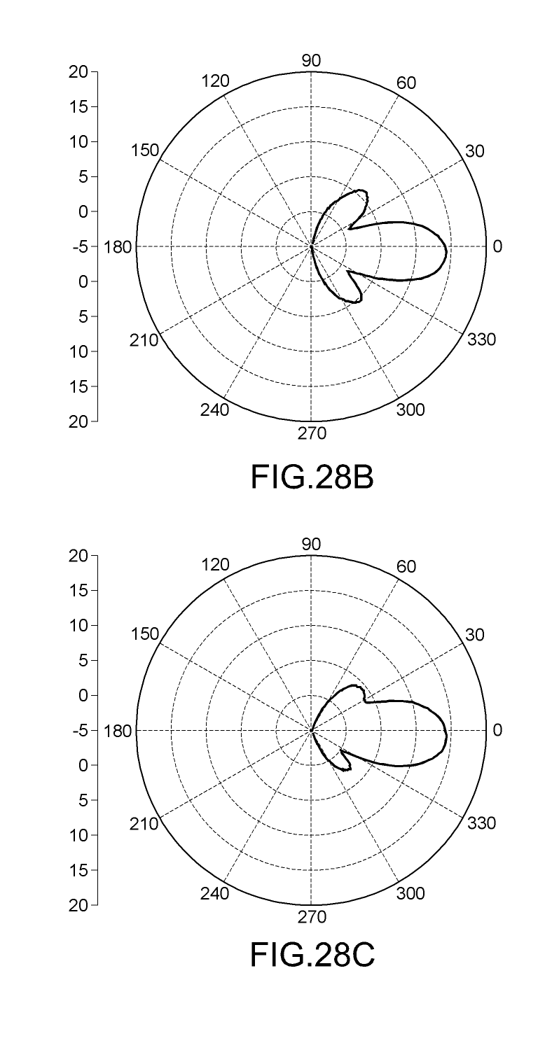

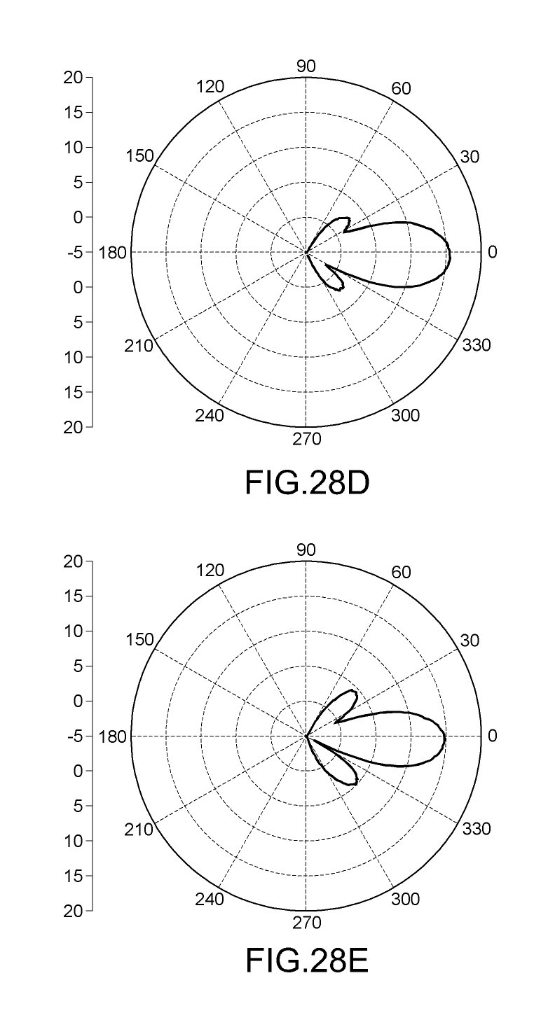

FIGS. 28A, 28B, 28C, 28D, and 28E are respectively diagrams of horizontal plane patterns of the third signal feed portion at frequencies of 5100 MHz, 5300 MHz, 5500 MHz, 5700 MHz, and 5900 MHz according to the fourth embodiment of the present invention, which are respectively tested at the frequencies of 5100 MHz, 5300 MHz, 5500 MHz, 5700 MHz, and 5900 MHz.

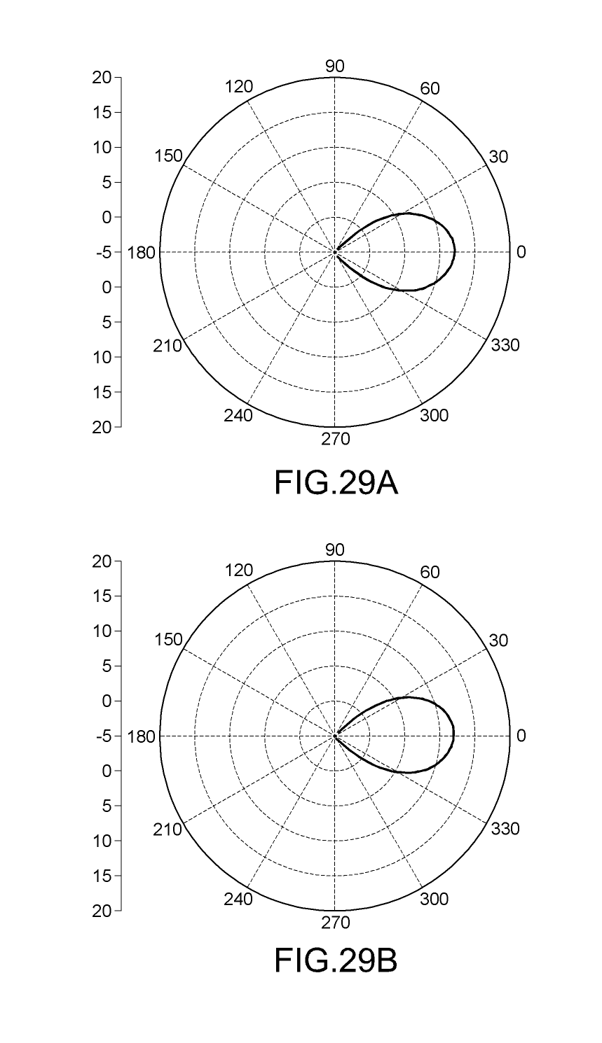

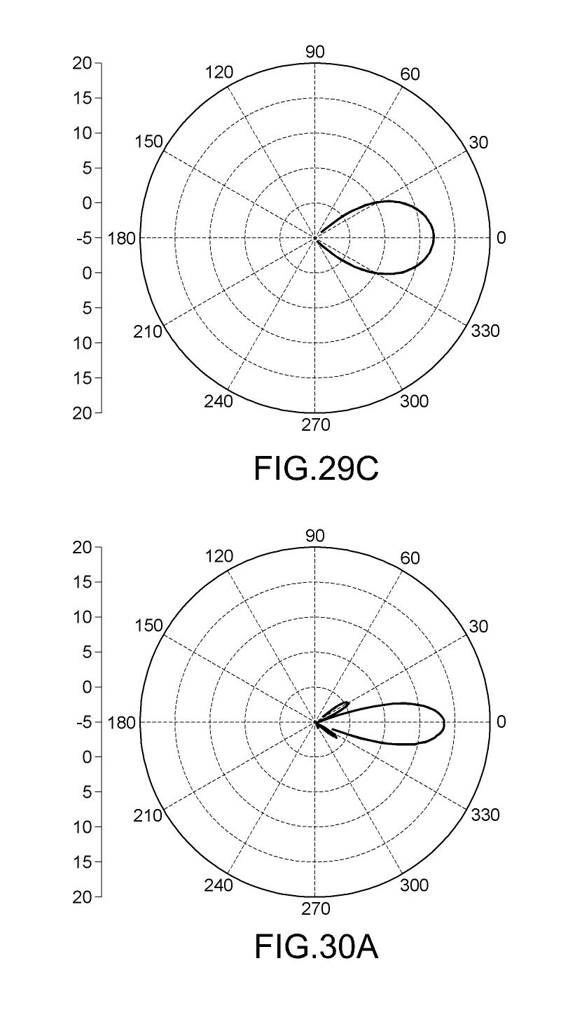

FIGS. 29A, 29B, and 29C are respectively diagrams of vertical plane patterns of the third signal feed portion at frequencies of 2400 MHz, 2450 MHz, and 2500 MHz according to the fourth embodiment of the present invention, which are respectively tested at the frequencies of 2400 MHz, 2450 MHz, and 2500 MHz.

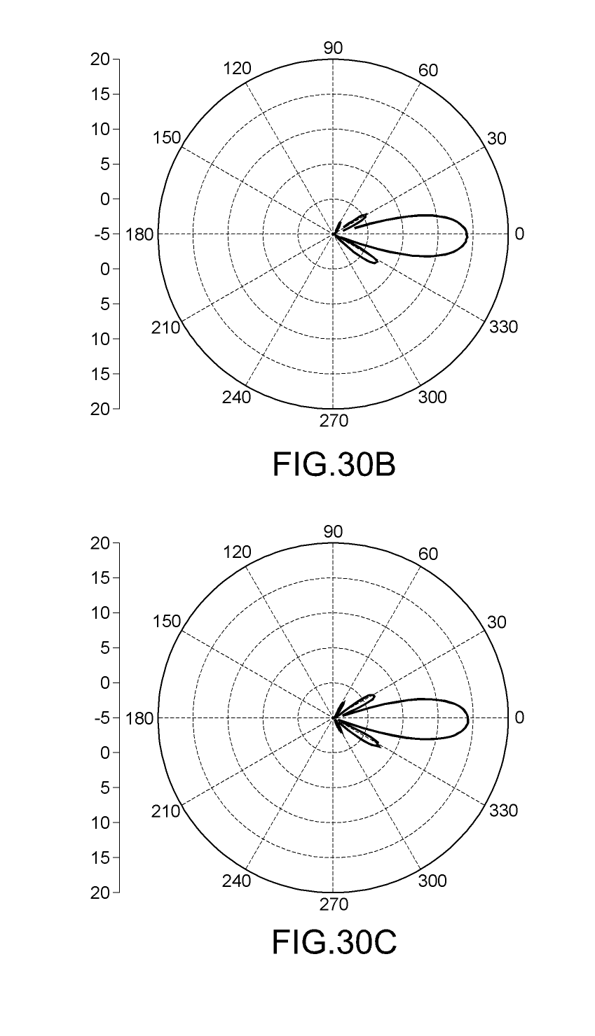

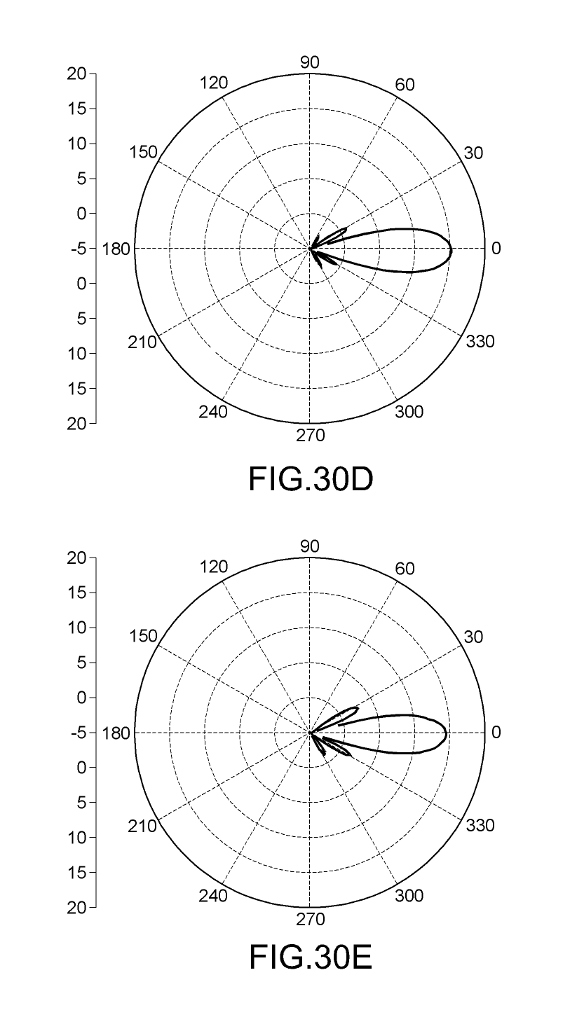

FIGS. 30A, 30B, 30C, 30D, and 30E are respectively diagrams of vertical plane patterns of the third signal feed portion at frequencies of 5100 MHz, 5300 MHz, 5500 MHz, 5700 MHz, and 5900 MHz according to the fourth embodiment of the present invention, which are respectively tested at the frequencies of 5100 MHz, 5300 MHz, 5500 MHz, 5700 MHz, and 5900 MHz.

Table 1 is a horizontal plane peak gain table of the first signal feed portion, the second signal feed portion, and the third signal feed portion at a frequency of 2400 MHz to 2500 MHz and at a frequency of 5100 MHz to 5900 MHz as collected from FIGS. 19A-19C, FIGS. 20A-20E, FIGS. 23A-23C, FIGS. 24A-24E, FIGS. 27A-27C, and FIGS. 28A-28E. As seen from Table 1, the maximum gains on the horizontal plane all exceed 10 dBi, and the maximum gain rises as the frequency is increased.

Table 2 is a vertical plane peak gain table of the first signal feed portion, the second signal feed portion, and the third signal feed portion at a frequency of 2400 MHz to 2500 MHz and at a frequency of 5100 MHz to 5900 MHz as collected from FIGS. 21A-21C, FIGS. 22A-22E, FIGS. 25A-25C, FIGS. 26A-26E, FIGS. 29A-29C, and FIGS. 30A-30E. As seen from Table 2, the maximum gains on the vertical plane all exceed 10 dBi, and the maximum gain rises as the frequency is increased.

Table 3 is a bandwidth table of the first signal feed portion, the second signal feed portion, and the third signal feed portion at a frequency of 2400 MHz to 2500 MHz and at a frequency of 5100 MHz to 5900 MHz as collected from FIGS. 19A-19C, FIGS. 20A-20E, FIGS. 23A-23C, FIGS. 24A-24E, FIGS. 27A-27C, and FIGS. 28A-28E. As seen from Table 3, the angle of the horizontal plane bandwidth is larger than 15 degrees, and the bandwidth is reduced as the frequency is increased.

Table 4 is a bandwidth table of the first signal feed portion, the second signal feed portion, and the third signal feed portion at a frequency of 2400 MHz to 2500 MHz and at a frequency of 5100 MHz to 5900 MHz as collected from FIGS. 21A-21C, FIGS. 22A-22E, FIGS. 25A-25C, FIGS. 26A-26E, FIGS. 29A-29C, and FIGS. 30A-30E. As seen from Table 4, the angle of the vertical plane bandwidth is larger than 20 degrees, and the bandwidth is bandwidth is reduced as the frequency is increased.

TABLE 1
Horizontal plane peak gain table at the frequency of
2400 MHz-2500 MHz and 5100 MHz-5900 MHz

| | Frequency ( MHz) | | | | | | |
|---|---|---|---|---|---|---|---|
| | 2400 | 2500 | 5100 | 5300 | 5500 | 5700 | 5900 |
| Peak gain of the first | 12.2 | 12.1 | 13.3 | 14 | 14.1 | 15 | 14.3 |
| signal feed portion | | | | | | | |
| (dBi) | | | | | | | |
| Gain of the second | 11.6 | 11.1 | 13.3 | 14.1 | 14.2 | 15.3 | 14.7 |
| signal feed portion | | | | | | | |
| (dBi) | | | | | | | |
| Gain of the third | 11.8 | 11.8 | 13.4 | 13.3 | 14.8 | 15 | 15.7 |
| signal feed portion | | | | | | | |
| (dBi) | | | | | | | |

TABLE 2
Vertical plane peak gain table at the frequency of
2400 MHz-2500 MHz and 5100 MHz-5900 MHz

| | Frequency ( MHz) | | | | | | |
|---|---|---|---|---|---|---|---|
| | 2400 | 2500 | 5100 | 5300 | 5500 | 5700 | 5900 |
| Peak gain of the first | 11.8 | 11.9 | 13.6 | 14.8 | 14.2 | 15.4 | 14.6 |
| signal feed portion | | | | | | | |
| (dBi) | | | | | | | |
| Gain of the second | 11.7 | 11.5 | 13.5 | 14.8 | 14.9 | 15.8 | 15.1 |
| signal feed portion | | | | | | | |
| (dBi) | | | | | | | |
| Gain of the third | 12.1 | 10.9 | 12.7 | 12.8 | 13.9 | 14.2 | 14.9 |
| signal feed portion | | | | | | | |
| (dBi) | | | | | | | |

TABLE 3
Horizontal plane bandwidth table at the frequency of
2400 MHz-2500 MHz and 5100 MHz-5900 MHz

| | Frequency ( MHz) | | | | | | |
|---|---|---|---|---|---|---|---|
| | 2400 | 2500 | 5100 | 5300 | 5500 | 5700 | 5900 |
| Bandwidth of the first | 40.7 | 39.4 | 19.9 | 19.1 | 18.6 | 18.6 | 17 |
| signal feed feed | | | | | | | |
| portion (degree) | | | | | | | |
| Bandwidth of the | 40.4 | 39.1 | 19.2 | 19.2 | 17.8 | 18.8 | 16.9 |
| second signal feed | | | | | | | |
| portion (degree) | | | | | | | |
| Bandwidth of the | 40.5 | 40.4 | 20.3 | 18.7 | 19.7 | 18 | 17.7 |
| third signal feed | | | | | | | |
| portion (degree) | | | | | | | |

TABLE 4
Vertical plane bandwidth table at the frequency of
2400 MHz-2500 MHz and 5100 MHz-5900 MHz

| | Frequency ( MHz) | | | | | | |
|---|---|---|---|---|---|---|---|
| | 2400 | 2500 | 5100 | 5300 | 5500 | 5700 | 5900 |
| Bandwidth of the first | 40.3 | 38.4 | 27.1 | 26.5 | 29.1 | 26.3 | 23.5 |
| signal feed portion | | | | | | | |
| (degree) | | | | | | | |
| Bandwidth of the | 41 | 39.2 | 26.0 | 28.4 | 29.5 | 26.4 | 24.6 |
| second signal feed | | | | | | | |
| portion (degree) | | | | | | | |
| Bandwidth of the | 41.5 | 38.9 | 29.4 | 26.1 | 25.6 | 28.6 | 23.2 |
| third signal feed | | | | | | | |
| portion (degree) | | | | | | | |

In the dual-frequency antenna according to the present invention, signals with two different frequency bands are fed in by the signal feed portions, and the two different frequency bands of the signals are respectively selected by the first filter and the second filter, and then the two different frequency bands are respectively transferred to a radiation signal of a radiation portion corresponding to each frequency band. Through coupling the metal layer corresponding to and covering each radiation portion, a coupling antenna takes the air between the radiation portion and the metal layer of the antenna as the media, so as to offer a relatively large space for combining the signal transmission lines and relevant circuits, thereby thereby realizing a dual-frequency, dual-polarized, and multi-feed antenna with broadband and high gain features.

What is claimed is:

1. A dual-frequency antenna, comprising:
a substrate, having a first surface and a second surface;
a ground layer, located on the second surface;
a plurality of signal feed portions, located on the first surface;
at least one first radiation portion, located on the first surface;
a plurality of second radiation portions, located on the first surface, wherein the plurality of second radiation portions and the at least one first radiation portion have different radiation frequency bands and serially connected in a staggered manner;
a plurality of first signal transmission lines, located on the first surface, wherein one end of each of the first signal transmission lines is connected to one of the at least one first radiation portion, and the other end thereof is connected to one of the plurality of signal feed portions, and among the plurality of first signal transmission lines, two first signal transmission lines are connected to the same first radiation portion in a dual-polarized input manner;
a plurality of second signal transmission lines, located on the first surface, wherein one end of each of the second signal transmission lines is connected to one of the plurality of second radiation portions, and the other end thereof is connected to one of the plurality of signal feed portions;
a plurality of first filters, respectively disposed on the plurality of first signal transmission lines, wherein each of the first filters is electrically connected between one of the plurality of signal feed portions and one of the at least one first radiation portion; and
a plurality of second filters, respectively disposed on the plurality of second signal transmission lines, wherein each of the second filters is electrically connected between one of the plurality of signal feed portions and one of the plurality of second radiation portions.

2. The dual-frequency antenna according to claim 1, further comprising:
a plurality of metal layers, wherein each of the metal layers is correspondingly disposed above one radiation portion of the at least one first radiation portion and the plurality of second radiation portions, and is electrically isolated from the at least one first radiation portion and the plurality of second radiation portions, so as to couple a radiation signal corresponding to the radiation portion.

3. The dual-frequency antenna according to claim 1, wherein among the plurality of second signal transmission lines, two second signal transmission lines are connected to the same second radiation portion in a dual-polarized input manner.

4. The dual-frequency antenna according to claim 1, wherein among the plurality of second radiation portions and the at least one first radiation portion that are serially connected in a staggered manner, two radiation portions located at two ends thereof are configured into a single-polarized input mode, and the other radiation portions are configured into a dual-polarized input mode.

5. The dual-frequency antenna according to claim 1, wherein among the plurality of second radiation portions and the at least one first radiation portion that are serially connected in a staggered manner, one of the two radiation portions located at two ends thereof is configured into a single-polarized input mode, and the other radiation portions are configured into a dual-polarized input mode.

6. The dual-frequency antenna according to claim 1, wherein all the radiation portions among the plurality of second radiation portions and the at least one first radiation portion that are serially connected in a staggered manner are configured into a dual-polarized input mode.

7. The dual-frequency antenna according to claim 1, wherein each first radiation portion comprises a plurality of first sub-radiation portions, and each two of the first sub-radiation portions are connected in parallel and electrically connected to at least one of plurality of first signal transmission lines.

8. The dual-frequency antenna according to claim 7, wherein each first sub-radiation portion comprises a plurality of first radiation units, connected in parallel and electrically connected to at least one of the plurality of first signal transmission lines.

9. The dual-frequency antenna according to claim 8, further comprising:
a plurality of metal layers, correspondingly disposed above each of the plurality of first radiation units one to one, electrically isolated from the plurality of first radiation units, and shielding each corresponding first radiation unit, so as to couple a radiation signal of each corresponding first radiation unit.

10. The dual-frequency antenna according to claim 1, wherein each of the second radiation portions comprises a plurality of second sub-radiation portions, connected in parallel and electrically connected to at least one of the plurality of second signal transmission lines.

11. The dual-frequency antenna according to claim 10, wherein each of the second sub-radiation portions comprises a plurality of second radiation units, connected in parallel and electrically connected to at least one of the plurality of second signal transmission lines.

12. The dual-frequency antenna according to claim 11, further comprising:
a plurality of metal layers, correspondingly disposed above each of the plurality of second radiation units one to one, electrically isolated from the plurality of second radiation units, and shielding each corresponding second radiation unit, so as to couple a radiation signal of each corresponding second radiation unit.

13. The dual-frequency antenna according to claim 1, wherein each of the first filters comprises a plurality of first filtering units, serially connected with each other in sequence.

14. The dual-frequency antenna according to claim 13, wherein each of the first filtering units comprises two filtering portions connected in parallel.

15. The dual-frequency antenna according to claim 1, wherein each of the second filters comprises a plurality of second filtering units, serially connected with each other in sequence.

16. The dual-frequency antenna according to claim 15, wherein each of the second filtering units comprises two filtering portions connected in parallel.
